(19) United States
(12) Patent Application Publication
(10) Pub. No.: US 2020/0179903 A1
(43) Pub. Date: Jun. 11, 2020

(54) Air Filters Comprising Metal-Containing Sorbents for Nitrogen-Containing Compounds

(71) Applicant: 3M INNOVATIVE PROPERTIES COMPANY, St. Paul, MN (US)

(72) Inventors: Brett A. Beiermann, St. Paul, MN (US); Austin D. Groth, Minneapolis, MN (US); Michael W. Kobe, Lake Elmo, MN (US); Derek M. Maanum, Minneapolis, MN (US); Michael S. Wendland, North St. Paul, MN (US)

(21) Appl. No.: 16/623,137

(22) PCT Filed: Jun. 13, 2018
(86) PCT No.: PCT/IB2018/054333

§ 371 Date: Dec. 16, 2019

Related U.S. Application Data
(60) Provisional application No. 62/520,718, filed on Jun. 16, 2017.

(51) Int. Cl. B01J 20/22; B01J 20/02; B01J 20/28; B01J 20/32; B01D 46/00; B01D 46/24; B01D 46/52; B01D 39/14; B01D 53/02; A62B 23/02

(52) U.S. Cl. CPC B01J 20/22; B01D 2259/4533; B01J 20/0288; B01J 20/28016; B01J 20/28028; B01J 20/2805; B01J 20/28083; B01J 20/3246; B01J 20/3206; B01J 20/3217; B01J 20/3295; B01D 46/0001; B01D 46/0032; B01D 46/0036; B01D 46/2411; B01D 46/521; B01D 39/14; B01D 53/02; A62B 23/025; B01D 46/2418; B01D 2239/0407; B01D 2239/0618; B01D 2239/10; B01D 2275/10; B01D 2239/065; B01D 2253/112; B01D 2253/25; B01D 2253/20; B01D 2257/406; B01J 20/0244

(57) ABSTRACT

An air filter including a filter support that supports metal-containing sorbent particles, the sorbent particles comprising a precursor that is a porous siliceous material that has been treated with a surface treatment agent, and a divalent metal incorporated into the siliceous precursor material.

### BACKGROUND

It is often desired to remove substances such as, e.g., ammonia, from air.

### SUMMARY

In broad summary, herein are disclosed air filters comprising filter supports that comprise metal-containing sorbent particles, the sorbent particles comprising a precursor that is a siliceous material that has been treated with a surface treatment agent, and a divalent metal incorporated into the siliceous precursor material. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF DRAWINGS

FIG. 1 depicts a portion of an exemplary air filter comprising a filter support comprising sorbent particles as disclosed herein.

FIG. 2 depicts a portion of another exemplary air filter.

FIG. 3 depicts a portion of another exemplary air filter.

FIG. 4 depicts a portion of another exemplary air filter.

FIG. 5 depicts a portion of another exemplary air filter.

FIG. 6 depicts an exemplary respirator comprising a filter support comprising sorbent particles as disclosed herein.

FIG. 7 discloses another exemplary respirator.

FIG. 8 discloses a framed, pleated air filter comprising a filter support comprising sorbent particles as disclosed herein.

### DETAILED DESCRIPTION

### Glossary

The term “air filter” denotes any apparatus or device in which herein-described sorbent particles, supported by a filter support, are presented to air, e.g. a stream of moving air, so that an airborne substance can be removed from the air. The term “filter support” denotes any structure that can retain sorbent particles and present them to, e.g., a stream of moving air, but that does not necessarily perform any filtration of microscopic particles from moving air. The term “filter media” denotes a filter support that is itself capable of filtering microscopic particles. A “microscopic” particle is a particle with an average diameter (or equivalent diameter, in the case of non-spherical particles) of less than 100 microns. A “fine” particle is a particle with an average diameter or equivalent diameter of less than 10 microns.

The terms “sorbent”, “sorbent particles”, “porous sorbent particles”, and the like are used interchangeably to refer to a particulate material (of any particle size) that is porous (e.g., mesoporous) and that can sorb airborne materials (e.g., gaseous or vaporous substances; in particular, basic, nitrogen-containing compounds as exemplified by ammonia).

The term “upstream” is applicable to a circumstance in which a filter is exposed to moving air, and refers to the direction from which moving air encounters a filter; “downstream” refers to the direction in which filtered air exits a filter.

The term “netting” refers to a filter support that is comprised of relatively few layers (five or less, often one) of solid material, e.g. filaments.

The term “fibrous web” refers to a filter support that is comprised of numerous layers (e.g., more than five) of fibers.

The term “meltblown” refers to fibers (and the resulting fibrous webs) that are formed by extruding molten polymer streams into converging high velocity air streams introduced by way of air-blowing orifices located in close proximity to the extrusion orifices. The skilled person will appreciate that meltblown fibers and webs will characteristically exhibit features and signatures (e.g., differences in the orientation of the molecules of the material making up the fibers, as revealed e.g. by optical properties such as birefringence, melting behavior, and so on) by which such fibers and webs can be identified and distinguished from other types of web.

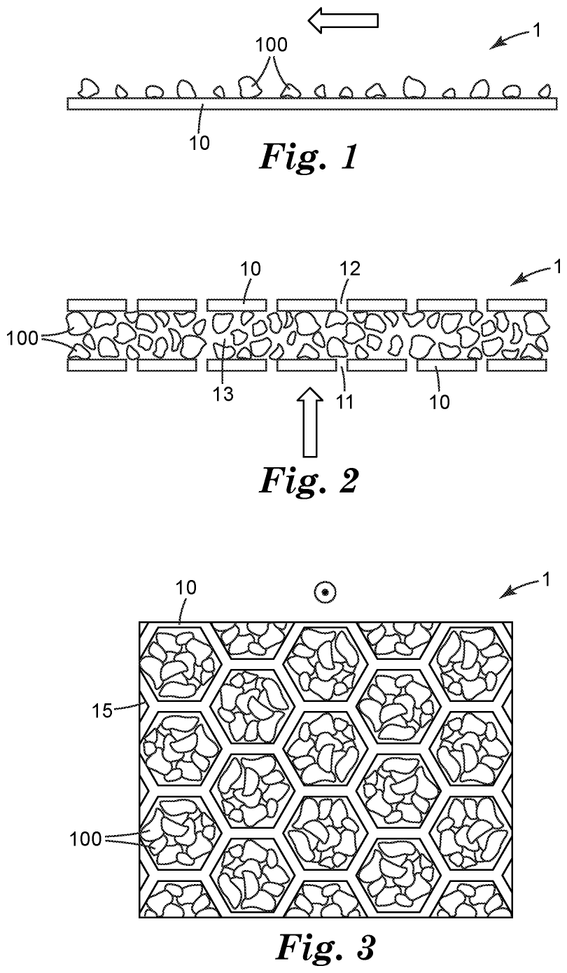

Disclosed herein is an air filter 1 as shown in generic representation in FIG. 1. Air filter 1 can be any apparatus or device that exposes herein-disclosed sorbent particles 100 to air, e.g. to a stream of moving air (with the general direction of airflow indicated in exemplary embodiment by the block arrow in FIG. 1 and in other Figures) so that airborne (e.g. gaseous or vaporous) basic, nitrogen-containing materials can be at least partially removed from the air. Air filter 1 is thus distinguished from devices that process liquids, for example ion-exchange membranes and devices.

Air filter 1 comprises at least one filter support 10. A filter support 10 can be any structure that supports sorbent particles 100 in such manner that exposes them to air, while retaining the sorbent particles so that, if the air is moving, the sorbent particles are not dislodged by the moving air. If the air is moving, it may encounter individual sorbent particles while in laminar flow or while in turbulent flow, or may transition between flow regimes in, for example, passing through a collection of sorbent particles. In embodiments of one general type, filter support 10 may take the form of a substrate on which sorbent particles 100 are provided (e.g., are attached to a major surface thereof) and across which e.g. a moving stream of air may traverse, as shown in generic representation in FIG. 1. In some embodiments of this type, filter support 10 may retain sorbent particles 100 e.g. by way of the sorbent particles being attached (e.g., adhesively bonded) to the filter support. In embodiments of another general type, a filter support 10 may retain sorbent particles 100 e.g. by mechanically retaining the sorbent particles within the filter support, as shown in generic representation in FIG. 2. (In other words, in such embodiments the sorbent particles may not necessarily be attached to the filter support, but the filter support can physically block the sorbent particles from being dislodged and removed from the filter support.) In some embodiments, a combination of mechanical retention, and attachment (e.g. bonding), of sorbent particles to the filter support may be employed.

In some embodiments, an air filter 1 may be (e.g., may consist essentially of) a filter support 10 comprising sorbent particles 100 (for example, a freestanding piece of such a filter support could be installed into e.g. a room air purifier). In other embodiments, an air filter 1 may comprise (in addition to the at least one filter support 10) other layers as desired for any purpose, and/or may additionally comprise any other ancillary components such as e.g. a perimeter frame, one or more reinforcing or stabilizing members, one or more housing pieces, and so on. Various specific exemplary embodiments and arrangements are discussed in detail later herein.

As noted with reference to FIG. 1, in some embodiments a filter support may take the form of a substrate (which substrate may be air impermeable, or air permeable) on a major surface of which sorbent particles 100 are disposed, e.g. attached. Air filters of this type may comprise, for example, a planar substrate bearing sorbent particles attached to a major surface thereof; a hollow tube with sorbent particles attached to an interior surface thereof; or, an array of flow-through channels provided by stacked or nested microstructured substrates (e.g., of the general type described in U.S. Pat. No. 7,955,570 to Insley) with sorbent particles attached to interior surfaces of the flow-through channels; and so on. In some embodiments sorbent particles 100 may be provided at least substantially as a monolayer on a surface of the substrate (e.g. as shown in FIG. 1), except for such occasional stacking as may occur statistically e.g. in any industrial-scale deposition process.

With reference to FIG. 2, the term filter support broadly encompasses any container that is designed to retain sorbent particles 100 therein and that includes at least one air inlet 11 for admitting air to the interior 13 of the container and at least one air outlet 12 to allow treated air to leave the container. Such supports of this general type may include well known filter cartridges in which sorbent particles 100 are retained within a cartridge housing made of e.g. one or more injection molded housing parts. In such filter cartridges, a single air inlet and/or outlet may be provided; or, a number of through-apertures may be provided in the filter cartridge housing to collectively provide an air inlet or outlet. Such through-apertures may be of appropriate size to prevent sorbent particles from passing therethrough; and/or, in some embodiments, an air-permeable protective layer (e.g., a screen or mesh) may be provided to ensure that the sorbent particles are retained within the cartridge housing. In some embodiments a filter support may be impermeable to air (e.g., may contain no through-apertures) in the locations of the support that are proximate to (e.g., that support and retain) sorbent particles, as in the design of FIG. 1. In other embodiments, a filter support may be permeable to air (e.g., may include one or more through-apertures) in locations of the support that are proximate sorbent particles, as in the design of FIG. 2. In some embodiments, a filter support in the form of a container (e.g., a filter cartridge) may be comprised of e.g. one or more injection molded housing parts that are assembled together and that may be air-impermeable except for the air inlet(s) and outlet(s). Such housing parts may be conveniently made of e.g. thermoplastic or thermoset polymers or copolymers chosen from e.g. polyamides, polystyrenes, ABS polymers, polyolefins, and so on. Such containers may also include ancillary components such as e.g. one or more resilient gaskets, latches, splash guards, connectors (e.g. as needed for connecting the cartridge to e.g. a personal respiratory protection device) and so on.

It is emphasized that a filter support 10 that is in the form of a container (as in e.g. FIG. 2) does not necessarily have to take the form of a rigid cartridge made e.g. of injection molded parts. Rather, in some embodiments such a container might take the form of e.g. two air-transmissive “walls” at least one of which is made of a relatively flexible material (e.g., a porous substrate such as a fibrous web, a perforated or microperforated flexible polymer film, and so on) with sorbent particles sandwiched between the two walls. Such a container (which may still be referred to in general as a filter “cartridge”) might take the form of e.g. a pouch or sachet.

Still further, the term filter support also broadly encompasses any porous, air-permeable material on which or within which sorbent particles 100 are disposed. (By a porous, air-permeable material is meant a material comprising internal porosity that is interconnected so as to allow airflow through the material, as distinguished from e.g. a closed cell foam.) Such materials might be e.g. open-celled foam materials of any suitable type; or, such a material might be a porous membrane; for example, a phase-inversion membrane, a track-etch membrane (e.g., of the type exemplified by various products available from Whatman under the trade designation NUCLEPORE); or, a stretch-expanded membrane (e.g., of the type exemplified by various products available from W.L Gore and Associates under the trade designation GORE-TEX and available from Celgard corporation under the trade designation CELGARD.) It will be appreciated that filter supports 10 of this general type are not limited to being used e.g. in pairs so as to define a space therebetween as described above. Regardless of the specific mode of use, such a filter support 10 may, in some embodiments, take the form of a sheet-like material that exhibits a major plane and that exhibits a thickness of less than about 8, 5, 3, or 1 mm and that is configured to allow airflow therethrough at least in a direction at least generally perpendicular to the major plane of the sheet-like material.

From the above discussions it will be appreciated that a filter support as disclosed herein widely embraces any material or arrangement, in any form or geometric shape (and whether consisting e.g. of a single entity such as a nonporous substrate, an air-permeable netting, or a porous foam, or made of an assembled combination of parts that collectively form a filter cartridge), that can present sorbent particles to air, e.g. to a stream of moving air. In some embodiments a filter support can be configured so that moving air may flow e.g. at least generally parallel to a major surface of the support that bears sorbent particles (e.g., as in the arrangement of FIG. 1). In some embodiments the moving air may flow at least generally perpendicular to a major surface of the support (e.g., as in the arrangement of FIG. 2). In some embodiments, moving air may flow in directions intermediate between these two extremes. In some embodiments, airflow in both directions and/or in directions intermediate between these two extremes, may occur e.g. in different portions of the air filter.

In embodiments of the general type illustrated in exemplary manner in FIG. 3, an air filter 1 may comprise a filter support 10 that is in the form of a “honeycomb” 15. The skilled person will recognize a honeycomb as being a flow-through support structure that comprises numerous macroscopic through-apertures that allow airflow therethrough, the apertures being separated from each other by partitions (walls) of the honeycomb structure. (While the term honeycomb is used here for convenience, the skilled person will appreciate that the structure may be of any geometry (e.g., with apertures that are square, triangular, round, etc.) and may exhibit a somewhat irregular appearance rather than being limited strictly to the regular hexagonal geometry shown in the exemplary design of FIG. 3.) Often, such honeycombs may comprise through-apertures with rather large diameter or equivalent diameter (e.g. from 10-15 mm), in contrast to the above-described stacked microstructured substrates, which may often comprise flow-through channels with a diameter or equivalent diameter of only e.g. a few mm or smaller. The walls of the honeycomb may be made of any suitable material, e.g. molded or extruded plastic, paperboard or cardboard, metal, and so on.

In some embodiments, sorbent particles may be attached to interior walls that define the apertures of the honeycomb. However, in some embodiments, it may be convenient to partially, or at least substantially, fill the apertures of the honeycomb with sorbent particles (to the extent permitted by packing behavior, depending e g on the average size, size distribution, and shape of the sorbent particles) as in FIG. 3. In such a case the honeycomb may be provided with upstream and downstream air-permeable substrates (e.g., suitable meshes or screens) that allow airflow to enter and exit the through-apertures of the honeycomb and yet retain the sorbent particles within the through-apertures of the honeycomb. (The direction of airflow in the exemplary honeycomb of FIG. 3 is out-of-plane as indicated by the circle/dot arrow.) In some embodiments, the sorbent particles may be packed loosely within the apertures e.g. so that the particles are able to move or shift slightly. In other embodiments, the sorbent particles may be bonded to each other (e.g., by use of an adhesive, a heat-activated binder, etc., in amounts sufficient to bond particles to each other at contact points but not in amounts that would unacceptably occlude the particles so as to impact their ability to capture airborne substances) e.g. so as to minimize shifting or settling of the particles within the apertures. In other words, in some embodiments (not necessarily limited to use in honeycombs) sorbent particles 100 may be provided in the form of a monolithic, air-permeable block (of any desired size and shape) collectively provided by an aggregation of particles that are bonded together, rather than being provided as individual particles. Exemplary methods of making such monolithic structures (which again, may have any suitable size and shape for incorporation into any desired air filter, for example, for fitting into a container such as e.g. a cartridge or canister, or for forming a layer of e.g. a respirator) are discussed e.g. in U.S. Pat. No. 5,033,465 to Braun. Methods of bonding sorbent particles together to make, in particular, a structure that is at least semi-flexible (and thus may be particularly suited for use in e.g. a flexible respirator mask), are discussed e.g. in U.S. Pat. No. 6,391,429 to Senkus.

The skilled person will appreciate that there may not necessarily be a firm dividing line between some of the above-mentioned embodiments (for example, between sorbent particles being provided within hollow tubes, versus being provided within channels defined by a stacked microstructured substrate, versus being provided within apertures of a honeycomb). All such designs and arrangements, and combinations thereof, are encompassed within the general concept of an air filter that comprises one or more filter supports as disclosed herein. It is noted in particular that in some embodiments, an air filter 1 as disclosed herein can comprise sorbent particles that are partially filled, or at least substantially filled, into the interior of any suitable container (of any geometric form and made of any material, whether e.g. rigid or at least semi-flexible) so as to form e.g. a packed bed. In some embodiments, such a container might take the form of a hollow tube, e.g. a tube resembling the gas-detection tubes often referred to as Dräger tubes.

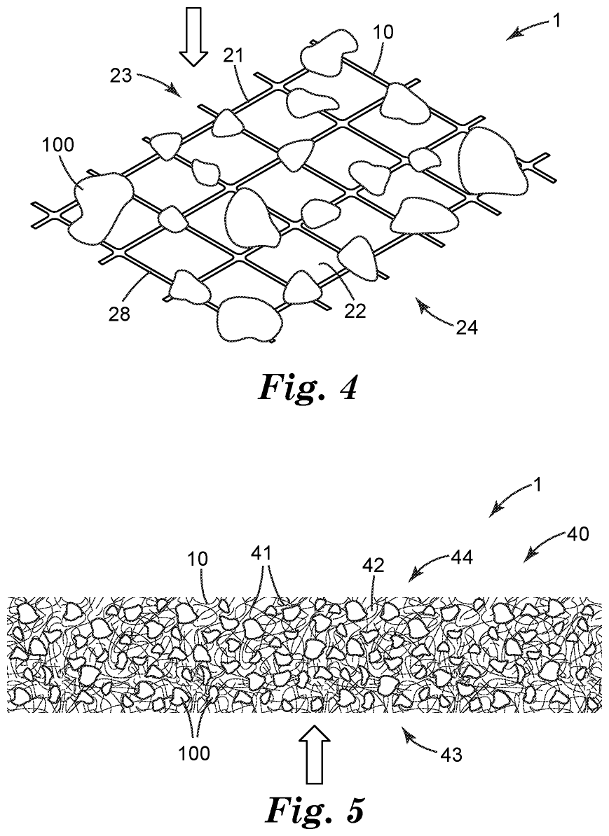

In some embodiments, a filter support 10 may comprise a thin, sheet-like material with numerous through-apertures 22 that allow airflow therethrough, as shown in exemplary, generic representation in FIG. 4. In various embodiments, filter support 10 may take the form of any suitable netting, mesh, screen, scrim, woven or knitted material, meltspun material, microperforated film, and so on. The term netting will be used herein for convenience in describing any such material, that is comprised of relatively few layers (five or less; often, a single layer as in FIG. 4) of filaments (or, in general, layers of solid material in between through-openings). Often, such filaments (or solid portions of a sheet-like filter support material, e.g. a microperforated film) are relatively large (for example, 0.1, 0.2, or 0.5 mm or more) in diameter or the equivalent thereof. Such a netting may be comprised of any suitable material, e.g. an organic polymer, an inorganic material (e.g., glass or ceramic), or a metal or metal alloy.

In such embodiments airflow may occur primarily through the through-apertures 22 between the solid portions 21 (e.g. filaments) of the netting so that the airflow is oriented at least generally perpendicular to the support; however, if desired the airflow could occur at least generally parallel to the netting. In the case of generally perpendicular airflow that passes through the netting, it may be convenient that the sorbent particles are positioned on the upstream side 23 of the netting (as in FIG. 4). However, if desired the sorbent particles may be positioned on the downstream side 24 of the netting. In particular embodiments, sorbent particles may be positioned on both sides of the netting. In some embodiments, a netting (or, in general, any sufficiently air-permeable substrate) comprising sorbent particles may be used “open-face” as in the illustrative embodiments of FIGS. 1 and 4. In other embodiments, a secondary retaining layer that is sufficiently air-permeable (e.g., a second layer of netting, or a layer of a fibrous web, a microporous membrane, or the like) may be positioned atop the sorbent particles to assist in retaining the sorbent particles in position. (In other words, the sorbent particles may be sandwiched between the netting and a secondary retaining layer.) In many embodiments, sorbent particles 100 may be bonded, e.g. adhesively bonded, to the solid material (e.g., filaments) of the netting, e.g. by way of an adhesive, e.g. a pressure-sensitive adhesive, a hot-melt adhesive, an epoxy adhesive, and the like 28 that is provided on at least one major surface of one side of the netting. Sorbent particles may each be bonded e.g. to a single filament, or may be bonded to multiple filaments. The average diameter of the filaments, and the average size of the through-apertures between the filaments, can be chosen in view of the average size of the sorbent particles if desired. In various embodiments, such nettings may exhibit an average filament diameter in the range of e.g. 0.2 mm to about 2.0 mm. In various embodiments, the openings of the netting may range from e.g. about 0.5 mm in shortest dimension to about 5 mm in longest dimension, and may be chosen in view of the particle size of the sorbent. By way of specific example, a netting with openings in a range of about 1-2 mm may be well suited for use with a sorbent that exhibits a particle size in the range of 8×20 mesh. Exemplary nettings that might be suitable for use as disclosed herein include various products available (e.g. under the trade designations DELNET) from Delstar Technologies; for example, the products available under the trade designations KX215P, R0412-10PR, RB0404-10P, N02014-90PP, RB0404-28P, N03011-90PP, and TK16-SBSH.

In particular embodiments, a suitable pressure sensitive adhesive 28 may be provided on a major surface of the netting (in other words, the pressure-sensitive adhesive may be provided on surfaces of the filaments that collectively provide that major surface of the netting). This may be done e.g. by coating a pressure-sensitive adhesive precursor onto the netting and then transforming the precursor into a pressure-sensitive adhesive. The precursor may be e.g. a solution in an organic solvent(s), an emulsion, a hot-melt composition, and so on. Such a precursor may be transformed e.g. by drying to remove solvent and/or water, by cooling to solidify a hot-melt composition, and so on. The deposition and transformation should be done in such manner as to avoid unacceptably filling or clogging the through-apertures of the netting (unless the airflow is not to pass through the netting in ordinary use of the filter).

It will be appreciated that in some embodiments particles that are disposed on a netting may be attached to the netting primarily due to e.g. adhesive bonding (rather than through e.g. mechanical entanglement). In some embodiments, the sorbent particles may be present on a filter support at least substantially in the form of a monolayer. In other embodiments sorbent particles may be present in multiple layers (made e.g. by adhesively bonding a first layer of sorbent particles to a major surface of a netting, applying additional adhesive atop the first layer of sorbent particles, depositing more sorbent particles, and repeating the process to build up a collection of sorbent particles of any desired depth).

In some embodiments a filter support 10 may comprise a sheet-like material comprised of numerous fibers, often entangled with each other and often present in numerous “layers” (e.g., more than five layers) as shown in exemplary embodiment in FIG. 5. The term fibrous web will be used herein for convenience in describing any such material. It will be appreciated of course that due to the random nature of many such fibrous webs, the fibers may not necessarily be, and often will not be, present in discrete layers (e.g., layers that can be peeled apart from each other); however, it will be readily apparent if e.g. five or more separate fibers or sections of fibers are encountered in traversing the thickness (depth) of such a web from a first major surface 43 thereof to a second major surface 44 thereof (as in FIG. 5). Any material exhibiting such a fiber arrangement falls under the definition of a fibrous web as used herein.

Often, such fibers may be relatively small (for example, less than 100, 80, 60, 40, 20, 10, 5, or 2 jun) in diameter or the equivalent thereof. Mixtures of fibers of various diameters may of course be used. Such a fibrous web may be any suitable type of web, e.g. a nonwoven web in which the fibers are relatively randomly arranged (e.g. except for such partial amounts of fiber alignment as may occur with e.g. carded webs and with certain types of fiber-deposition methods). Alternatively, such a fibrous web may be comprised of a knitted or woven web in which the fibers are provided in a sufficient number of layers. Typically, air will flow through the web by passing through interstitial spaces between the numerous fibers of the web; often, such airflow is oriented at least generally perpendicular to a major plane of the fibrous web as in FIG. 5. However, if desired the airflow could occur at least generally parallel to a major plane of the fibrous web. The fibers of such a fibrous web can be bonded to each other (so that the web has sufficient mechanical integrity to be processed and handled) in any suitable manner. Such bonding methods might be chosen from e.g. hydroentangling, needle-punching, calendering, and the like. In some embodiments, the fibers may be autogenously bonded to each other, meaning that the fibers are bonded at an elevated temperature as obtained in an oven or with a so-called through-air bonder without application of solid contact pressure such as in point-bonding or calendering. In particular embodiments, the fibers may be bonded using autogenous bonding methods of the general type described in U.S. Pat. No. 7,947,142 to Fox (in which a stream of heated air is passed through the collection of fibers followed by forceful quenching). Or, one or more binders (whether in the form of fibers, solid particles, a water-born emulsion, and so on) may be added and then activated (e.g. by heating) to bond the fibers together to form the final web. Any such bonding operation (whether achieved primarily mechanically by entanglement of fibers, or by use of a melt-bonding of fibers and/or by use of an added binder) may additionally serve to bind sorbent particles into or onto the web, as noted below.

In some embodiments sorbent particles 100 may be deposited primarily, or exclusively, on a major surface (e.g., a major upstream surface) of the fibrous web, in somewhat similar manner to the arrangement of particles on the netting of FIG. 4. In some embodiments at least some of the sorbent particles may penetrate at least partly into the interior of the fibrous web. (This is in contrast to the situation with a netting provided by e.g. a monolayer of filaments as in FIG. 4, in which case the support exhibits little or no “interior” into which sorbent particles could penetrate.) In some such embodiments the sorbent particles may be found primarily in the region of the fibrous web proximate the major surface onto or into which the sorbent particles were deposited. In many embodiments, however, it may be desirable to provide that sorbent particles 100 are distributed widely throughout the thickness of the fibrous web (as shown in exemplary embodiment in FIG. 5), as opposed to the particles being e.g. deposited onto one surface so that they either remain on the surface or only penetrate a short distance into the interior of the fibrous web. Suitable methods of forming fibrous webs with sorbent particles distributed widely (e.g., randomly) throughout the interior of the web are discussed later herein.

In particular embodiments, a fibrous web filter support may be a nonwoven web. By definition, nonwoven fibrous webs do not encompass e.g. woven or knitted webs or microperforated films. Such a web can be made by any suitable method and can be of any suitable type. For example, such a nonwoven web might be: a carded web; a wet-laid web (made e.g. by papermaking processes); a dry-laid web made e.g. by a conventional airlaying process such as the well-known Rando-Webber process, or made by a specialized process such as the gravity-laying process described in U.S. Pat. No. 8,834,759 to Lalouch; or, a meltspun web (e.g. a spunbonded web, a spunlaced web, and so on). (It will be appreciated that certain e.g. spunbonded or spunlaced webs may qualify as nettings rather than as fibrous webs, depending e.g. on the depth of fibers that are laid down.) In particular embodiments, the nonwoven web may be a meltblown web, which process and resulting web will be well known to the skilled person. Any combination of layers of these various materials (including combination with layers that are not nonwoven webs) can be used. The fibers may be made of any suitable material, e.g. thermoplastic organic fibers (such as e.g. polyolefin fibers, cellulosic fibers, polyester fibers, nylon fibers, etc.), inorganic fibers (such as e.g. fiberglass or ceramic fibers), metal fibers, and so on.

Sorbent particles 100 may be provided on and/or within a porous material, e.g. a fibrous web such as a nonwoven web to form a herein-disclosed filter support of an air filter, by any suitable method. In some embodiments, the sorbent particles may be deposited on or into a pre-existing fibrous web. For example, in some embodiments a nonwoven web may comprise one or more binding components such as bondable fibers and/or a non-fibrous binder (a non-fibrous binder may take the form of e.g. particles, an emulsion or latex, and so on). The web may be heated to a temperature to soften and activate such a binding component(s), and the sorbent particles may then be deposited onto a major surface of the nonwoven web to be bonded thereto. It will be appreciated that many such processes may preferentially result in sorbent particles being present on or proximate a major surface of the nonwoven web onto which the sorbent particles were deposited. If desired, such a process may be repeated multiple times with the successive layers being bonded together to form a multilayer product comprising sorbent particles therein.

In other embodiments, the sorbent particles may be introduced into a nonwoven web during the process of making the web. For example, if a nonwoven web is made by meltblowing, it may be convenient to introduce the sorbent particles into the flowing stream of incipient fibers (the term incipient fibers refers to molten streams that may or may not have begun to solidify into fibers, or finished solidifying into fibers). General methods of performing such operations are disclosed in US Patent Application Publication No. 20120272829 to Fox, which is incorporated by reference herein. The incipient fibers may be deposited (e.g., onto a temporary collection surface or onto a secondary web that remains as part of the filter support) in a condition in which the incipient fibers are at least slightly sticky (bondable). Such arrangements can provide that at least some of the fibers of the meltblown nonwoven web are bonded (e.g., melt-bonded) to the sorbent particles. In this manner a meltblown web can be made comprising sorbent particles therein, in a single operation.

Of course, it is also possible to use other methods to introduce sorbent particles into a mixture of fibers prior to the fibers being collected as a web. For example, sorbent particles may be mixed with fibers that are input to a web-formation process (e.g., the above-mentioned gravity-laying web-formation process), to form a collected mass of fibers comprising sorbent particles therein. Such an approach can include adding binder (whether in the form of fibers, or as non-fibrous binders such as particles, an emulsion, etc.) to the input materials so that the collected mass of fibers can be heated to bind the fibers together to form a web and/or to bond the sorbent particles into the web. Whatever approaches is/are used, the primary mechanism by which sorbent particles are bound into or onto the fibrous web can be the same or different from the binding mechanism that is used to bind the fibers together to form the web. With particular regard to a meltblown fibrous web, a variety of fiber-forming polymeric materials may be used to form such fibers. At least some fibers may be made of a material that exhibits sufficient bonding (adhesive) properties under the conditions (e.g., melt-blowing conditions) used in making the nonwoven web. Examples include thermoplastics such as polyurethane elastomeric materials, polybutylene elastomeric materials, polyester elastomeric materials, polyether block copolyamide elastomeric materials, polyolefin-based elastomeric materials (e.g., those available under the trade designation VERSIFY from Dow), and elastomeric styrenic block copolymers (e.g., those available under the trade designations KRATON from Kraton Polymers, Houston, Tex.). Multicomponent fibers (e.g., core-sheath fibers, splittable or side-by-side bicomponent fibers and so-called “islands in the sea” fibers) in which at least one exposed surface of the fibers (e.g., the sheath portion of a core-sheath fiber) exhibits sufficient adhesive properties, may also be used.

In some embodiments, fibers that are able to bond to sorbent particles 100 may be the only fibers present in the meltblown web. In other embodiments, other fibers (e.g. that do not participate to any significant extent in bonding the sorbent particles) may be present e.g. as long as sufficient bondable fibers are present. In various embodiments, bondable fibers may comprise at least about 2 weight percent, at least about 4 weight percent, and at least about 6 weight percent of the meltblown nonwoven web. In further embodiments, bondable fibers may comprise no greater than about 20 weight percent, no greater than about 17 weight percent, and no greater than about 15 weight percent of the meltblown nonwoven web. Any nonbondable fibers that are present in the web may be of any suitable type and composition; for example, any of the well known polyolefinic fibers (e.g. polypropylene, polyethylene, and the like) may be used, as may any of the well known polyester fibers. In at least some embodiments, the nonwoven web is essentially free of any added binder of any kind. That is, in such cases essentially all binding of the sorbent particles (to retain them in the meltblown nonwoven web) is performed by the bondable fibers. Such embodiments thus exclude the presence of binder in such forms as particles or powders, liquids such as latexes, emulsions, suspensions, or solutions, and so on.

It will be appreciated that the above discussions have concerned methods in which bonding of fibers to the sorbent particles is at least partially used to retain the particles within the nonwoven web. Physical entanglement of the sorbent particles within the fibers can also assist in retaining the sorbent particles within the nonwoven web. In some embodiments, a secondary air-permeable layer (e.g. a scrim or facing) can be applied to (e.g., bonded to) one or more major surfaces of the nonwoven web to minimize the chances of any of the sorbent particles becoming dislodged therefrom. In fact, in some embodiments it may be convenient to deposit the incipient fibers that will form a meltblown nonwoven web (along with the sorbent particles that are merged into the stream of incipient fibers), onto a major surface of a secondary web (e.g., scrim or facing) so that the meltblown web is bonded to the secondary web in the act of making the meltblown web.

In some embodiments, air filter 1 may comprise at least one filter media 40. A filter media is a filter support 10 that can retain sorbent particles 100 and expose them to air; beyond this, a filter media is a particular type of filter support that is capable of filtering significant amounts of microscopic particles (i.e., particles of average diameter of 100 microns or less) from moving air. A filter media 40 may comprise any material that can provide an air-permeable network structure into or onto which sorbent particles can be incorporated so as to present the sorbent particles to an airstream that is moving through the air-permeable network structure, and that furthermore is itself capable of filtering microscopic particles. Such a filter media might be e.g. a nonwoven web that is a meltblown and/or charged web.

As noted, a filter media is able to capture a significant amount of microscopic particles (with diameter 100 μm or less). In specific embodiments, a filter media may be able to capture a significant amount of fine particles in the range of e.g. 10 μm or less, or even in the range of 2.5 μm or less. In particular embodiments, the filter media may be capable of performing HEPA filtration. It will be appreciated that use of electret (charged) materials as described below, may substantially enhance the ability to perform e.g. fine-particle filtration or HEPA-filtration. In various embodiments, a filter media 40 may exhibit a Percent Penetration (specified herein as using Dioctyl Phthalate as a challenge material, and tested using methods described in U.S. Pat. No. 7,947,142 to Fox) of less than about 80, 70, 60, 50, 40, 30, 20, 10, or 5. All processes (e.g., fiber-bonding, charging, pleating, and the like), parameters and characterizations that are described herein with respect to filter supports in general, may be applied in particular to filter media.

In some embodiments, a nonwoven web (e.g., a meltblown nonwoven web) for use as a filter support (or, in particular, as a filter media) may include electrostatically charged fibers. Charging of such fibers may be done by any suitable method, for example, by imparting electric charge to the nonwoven web using water as taught in U.S. Pat. No. 5,496,507 to Angadjivand, or as taught in U.S. Patent Publication No. 2009/0293279 to Sebastian. Nonwoven electret webs may also be produced by corona charging as described in U.S. Pat. No. 4,588,537 to Klaase, or using mechanical approaches to impart an electric charge to fibers as described in U.S. Pat. No. 4,798,850 to Brown. Any combination of such approaches may be used. Fibers may be charged before being formed into the nonwoven web, or after the nonwoven web is formed. (In any case, any such charging may be conveniently performed before the air filter media is pleated, if it is to be pleated.) In the case that an air filter is to include a particle-filtration layer that is a different layer from filter support 10 (as described below), such a particle-filtration layer may be charged if desired, e.g. by any of the above approaches.

If the filter support (whether free-standing, or part of a multilayer assembly) is to be pleated, pleat formation and pleat spacing may be performed using any suitable technique including those disclosed in U.S. Pat. No. 4,798,575 to Siversson, U.S. Pat. No. 4,976,677 to Siversson, and U.S. Pat. No. 5,389,175 to Wenz. Pleating procedures that may be useful are also described e.g. in U.S. Pat. No. 7,235,115 to Duffy. (It will be appreciated, however, that in at least some embodiments the use of score-pleating may be avoided since the scoring process may serve to crush at least some of the sorbent particles.) In various embodiments, the pleated air filter support may include about 0.5 to about 5 pleats per 2.5 centimeters. More specifically, the pleat spacing may be e.g. from about 6, 8, 10, or 12 mm, to about 50, 40, 30, 20, or 15 mm. In various embodiments, the pleat height may be e.g. from about 15, 20, 25, or 30 mm, to about 100, 80, 60 or 40 mm.

An air filter 1 may comprise a filter support 10 (which by definition supports at least some sorbent particles 100) that consists of a single layer; or, multiple layers of filter support 10 (e.g., each layer including at least some sorbent particles 100) may be present in an air filter 1. Particularly if the filter support(s) 10 is not itself an air filter media as defined herein, the air filter 1 may include (in addition to the at least one filter support layer 10) one or more particle-filtration layers (e.g., capable of filtration of microscopic particles, fine particles, and/or HEPA filtration) that do not include sorbent particles 100. Such a particle filtration layer may be electrostatically charged if desired, and in various embodiments may exhibit a Percent Penetration of less than about 80, 70, 60, 50, 40, 30, 20, 10, or 5. (The term particle broadly encompasses e.g. aerosols, dust, mist, fumes, smoke, mold, bacteria, spores, pollen, and so on.) In particular embodiments, such a particle-filtration layer may be a high-loft spunbonded nonwoven web e.g. of the type described in U.S. Pat. No. 8,240,484 to Fox, and comprising a solidity of from less than 8%, to about 4%, and that is comprised of meltspun fibers that are substantially free of crimped fibers, gap-formed fibers and bicomponent fibers.

Regardless of whether or not any particle-filtration layers are present, an air filter 1 may comprise (in addition to at least one filter support layer 10 and any optional particle-filtration layers) one or more secondary layers (e.g., scrims, nettings, covers, and so on), e.g. to serve as a cover layer, a coarse prefilter, a carrier layer, a skin-contacting layer, to provide mechanical support or stiffness, and so on. That is, in general, and without regard to the particular type, configuration or construction of a filter support layer 10, such a filter support layer may be provided as one layer of a multilayer air-permeable assembly (stack) that can collectively provide an air filter 1. Any such multilayer stack may of course be pleated, framed, and so on, as described herein.

The herein-disclosed sorbent particles (whether e.g. dispersed within a nonwoven fibrous web, disposed on a surface of a substrate, filled into a receptacle(s) e.g. to form a packed bed, etc.), may be used in combination with any secondary sorbent particles, configured to capture any desired component present in air (e.g. a noxious gas/vapor). In some embodiments, such secondary sorbent particles may be present in a separate layer that is e.g. upstream or downstream of sorbent particles 100. In other embodiments, sorbent particles 100 and any desired secondary sorbent particle(s) may be mixed together. Secondary sorbent particles (whether used in a separate layer or as a commingled mixture with sorbent particles 100) may be chosen from, for example, activated carbon, alumina and other metal oxides, clay, hopcalite, ion exchange resins, molecular sieves and zeolites, silica, sodium bicarbonate, metal-organic frameworks (MOFs), and so on including combinations of any of these materials. In some embodiments, secondary sorbent particles (e.g. activated carbon) may be impregnated sorbent particles that are suitably impregnated with e.g. any desired metal salt or compound. Various particles that may be suitable for use as secondary sorbent particles are described in detail in U.S. Patent Application Publication No. 2015/0306536 to Billingsley and in U.S. Provisional Patent Application No. 62/298,089, entitled METAL-CONTAINING POLYMERIC MATERIALS, which are incorporated by reference in their entirety herein. Any combination of any of such particles may be used. Sorbent particles 100 and one or more sets of secondary sorbent particles may be used in any weight ratio. In particular, the term “secondary” is used for convenience of description and does not require that any secondary sorbent particles must be present, for example, in a lower amount than the sorbent particles 100. Furthermore, the disclosed sorbent particles 100 may be mixed e.g. with particles, granules or the like, that are not porous and/or do not perform any sorbing function (such particles may e.g. perform a spacing or separating function).

In some embodiments, an air filter 1 comprising sorbent particles 100 as disclosed herein, may be used in combination with a secondary air filter that is provided separately from air filter 1. In some embodiments, an air filter 1 and a secondary air filter may be separately installed into different areas of an air-handling apparatus. (For example, an air filter 1 and a secondary air filter may each be a framed air filter and may each be separately inserted e.g. into a room air purifier.) Alternatively, an air filter 1 and a secondary air filter may be assembled together (and e.g. attached to each other) before being installed into e.g. an air-handling apparatus. Air filter 1 can be placed e.g. upstream or downstream of the secondary air filter (if air filter 1 is upstream, it may serve e.g. as a prefilter for the secondary filter). In some exemplary embodiments, a secondary air filter may be configured e.g. to capture fine particles, and may exhibit a Percent Penetration of e.g. less than about 80, 70, 60, 50, 40, 30, 20, 10, or 5.

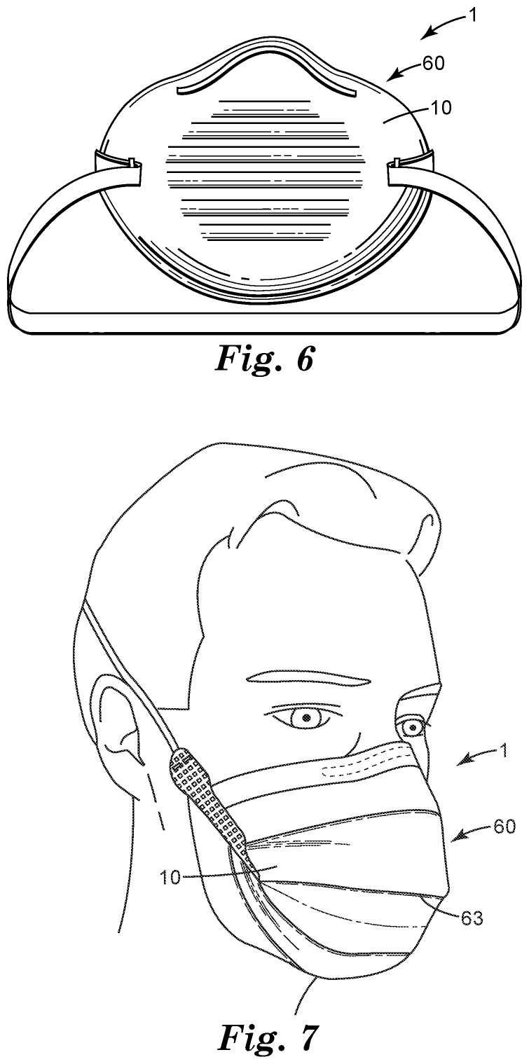

A filter support 10 comprising sorbent particles 100 as disclosed herein may be used in any kind of air filter 1, configured for any suitable end use. By way of specific examples, filter support 10 may find use in e.g. an air filter that is, or is part of, a personal respiratory protection device. It has already been noted that filter support 10 may take the form of a filter cartridge that can be fluidly coupled to a mask body to provide a personal respiratory protection device (e.g., the filter cartridge being disposable and the mask body being a piece that is shaped to fit a user's face and that is retained and a replacement filter cartridge attached thereto at an appropriate time). In other embodiments, filter support 10 may be incorporated into a “filtering face-piece” respirator mask 60. In products of this general type, the mask body itself provides the filtering function. That is, unlike respirators that use mask bodies in conjunction with attachable filter cartridges or the like, filtering face-piece respirators are designed to have the filtration layer(s) present over much or essentially all of the entire mask body so that there is no need for installing or replacing a filter cartridge. (That is, in a filtering face-piece respirator the mask body itself performs the filtering function rather than relying on one or more cartridges attached thereto.) Filtering face-piece respirators 60 often come in one of two configurations: molded (e.g. shaped, into a generally cup-shape so as to fit on a user's face) as shown in exemplary representation in FIG. 6, and flat-fold, that can be supplied in a flat or nearly-flat condition and can then be unfolded and expanded to fit on a user's face, as shown in exemplary representation in FIG. 7.

Such a respirator mask (whether e.g. a flat-fold or molded respirator) 60 may comprise any desired ancillary layers (e.g., one or more cover layers, stiffening layers, pre-filter layers, and the like) and components (e.g. one or more exhaust valves, attachment bands or strings, nose-pieces, and so on). If used in a flat-fold respirator mask, filter support 10 may often take the form of a relatively flexible layer (e.g. with one or more preferential folding lines 63 provided to make the material more easily foldable). If filter support 10 is to be used in a molded respirator mask (that is not designed to be foldable), filter support 10 may be e.g. a semi-rigid material (noting however that since in many molded, cup-shaped respirator masks much of the stiffness may be provided by a stiffening layer that is separate from the filtering layer(s), it may not be strictly necessary that filter support 10 be rigid, or even semi-rigid, for use in such a product).

It will be appreciated that the above-described uses fall primarily into the category of so-called “negative-pressure” respirators; that is, products in which the motive power for moving air is the breathing of a user rather than a separately provided motorized fan. Such negative-pressure respirators are often configured as e.g. full-face respirators, half-face respirators, and hoods (e.g., escape hoods, smoke hoods, and the like). All such products are encompassed by the term negative-pressure respirator as used herein, and filter support 10 may be used with any such product.

In other embodiments, filter support 10 may be used in a respirator in which the motive power for moving air is a motorized fan or blower. Such products may include e.g. a PAPR (powered air purifying respirator). In such products, filter support 10 (and, in general, air filter 1) may be located proximate the user's face or head; or, it may be located remotely (e.g., positioned in a receptacle of a belt-worn housing).

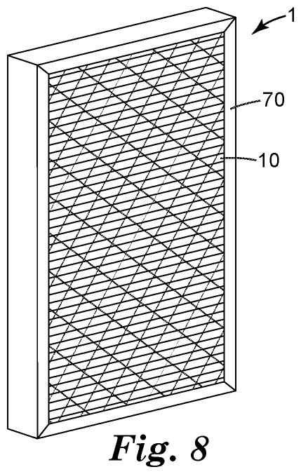

In some embodiments as shown in exemplary embodiment in FIG. 8, a filter support 10 (e.g., whether pleated or not, and whether or not including any other layers such as particle-filtration layers, etc.) may be incorporated into an air filter 1 that includes a perimeter frame 70 (e.g. a rigidifying or supporting frame), which may be e.g. arranged around a perimeter edge region of the filter support. Suitable materials for the frame include chip board, or paperboard, synthetic plastic materials and metal. Suitable frame constructions might be chosen from e.g. the “pinch” frame construction illustrated in FIGS. 1-4 of U.S. Pat. No. 6,126,707 to Pitzen, the “box” frame construction illustrated in FIGS. 5 and 6 of the '707 patent, the hybrid frame construction illustrated in FIGS. 7-11 of the '707 patent, any of the frame constructions disclosed in U.S. Pat. No. 7,503,953 to Sundet, and any of the frame constructions disclosed in U.S. Pat. No. 7,235,115 to Duffy. Any such frame may be attached to the filter support by any suitable method, e.g. hot-melt bonding, room-temperature glue, and so on.

An air filter 1 (whether framed or not) comprising filter support 10 may be advantageously used to filter moving air in any suitable powered air-handling system, e.g. in HVAC systems (e.g., in forced-air heating, cooling, and/or heating/cooling systems often used in residences, office buildings, retail establishments, and so on). Such filters may also find use in room air purifiers, motor vehicles (such as in e.g. cabin air filtration of automobiles), clean rooms, operating rooms, and the like. In some embodiments, air filter 1 (e.g., as part of a filter cartridge) may be inserted into an air pathway of a powered air-purifying respirator, as noted above. While in any or all such uses it may not be necessary that air filter 1 be a framed air filter, in many such uses it may be advantageous for air filter 1 to be a framed air filter.

The above discussions all relate to methods of providing sorbent particles 100 on a suitable filter support 10 to provide an air filter 1 and positioning the air filter so that the supported sorbent particles are exposed to air (the term air is used broadly and encompasses any gas or gaseous mixture, e.g. nitrogen, dehumidified nitrogen or air, oxygen-enriched air, air including an anesthetic gas or gas mixture, and so on). In many embodiments, the air to which the sorbent particles are exposed is in the form of a moving airstream. In some cases (which may be referred to as “active” filtration) such moving air may be motivated by a motorized blower, fan, and so on. In other cases (which may be referred to as “passive” filtration) such moving air may be motivated e.g. by the breathing of a person rather than by any motorized mechanism. The term “passive” filtration also encompasses situations in which an air filter 1 is exposed to currents, eddies, and the like, e.g. in an ambient atmosphere. Such currents and eddies might take the form of e.g. wind (such as might be impinged against an exterior surface of a filter support 10 that is provided in the form of e.g. a window screen). Or, in indoor environments, such currents and eddies might take the form of convection currents, random air currents, and the like, which regularly occur e.g. in rooms of buildings (due e.g. to doors opening and closing, persons moving, and so on). It will thus be appreciated that an air filter 1 as disclosed herein encompasses such devices as e.g. a cartridge, bag, pouch, canister, or, in general, any kind of container that holds sorbent particles 100 therein and that has at least one air-permeable wall so as to allow air to enter the container and contact the sorbent particles and to then exit the container, regardless of whether such a device is or is not used with any kind of mechanical blower or is used in any kind of respirator.

In broad summary, air filters 1 as described herein can find use in any suitable application in which it is desired to remove at least some basic, nitrogen-containing airborne substances from air. Such uses may involve personal devices (e.g. personal respiratory protection devices) designed for use by a single user, or collective devices (e.g. room air purifiers, HVAC systems, and so on) designed for e.g. buildings, vehicles, and other places where persons reside, work, or gather. As noted, such uses may involve “active” or “passive” filtration, and may use an air filter 1 that is configured in any of a wide variety of geometric formats and that is comprised of any of a wide variety of materials. Also as noted, one or more secondary sorbents may be used in addition to the herein-described sorbent particles 100, whether mixed with particles 100 and/or provided in a separate layer. As further noted, an air filter 1 may include at least one layer (in addition to the at least one support layer 10 that supports sorbent particles 100) that provides fine-particle filtration and/or that captures some gas/vapor other than basic, nitrogen-containing materials such as ammonia. Instead of this, or as an adjunct to this, a secondary air filter may be provided in addition to air filter 1, e.g. to perform filtration of fine particles and/or to capture some other gas/vapor. Moreover, combinations of any of the above-described embodiments of filter supports may be used. For example, sorbent particles 100 might be disposed within a fibrous web, or onto a surface of a netting, which web or netting might e.g. be placed within a housing to provide a filter cartridge.

Sorbent particles 100 are metal-containing sorbent materials that can sorb basic, nitrogen-containing compounds (particularly those compounds that are volatile under use conditions). More specifically, the metal-containing sorbent particles are materials that include a) a precursor that is a porous siliceous material that has been treated with a surface treatment agent and b) a divalent metal incorporated into the siliceous precursor material. When the metal-containing sorbent material sorbs basic, nitrogen-containing compounds, metal complexes are formed within the sorbent material. That is, the reaction product of the metal-containing sorbent material and the basic, nitrogen-containing compounds is a composite material that contains metal complexes.

In further detail, the metal-containing sorbent includes a) a precursor and b) a divalent metal incorporated into the precursor in an amount equal to at least 1 weight percent based on the total weight of the sorbent. The precursor includes a reaction product of a mixture containing 1) a porous siliceous material and 2) a surface treatment agent. The porous siliceous material has mesopores. The surface treatment agent is added in an amount in a range of 0.1 to 4.5 mmoles per gram of the porous siliceous material. The surface treatment agent is a silane of Formula (I), a disilazane of Formula (II), or a mixture of the silane of Formula (I) and the disilizane of Formula (II).

R¹—Si(R²)₃₋ₓ(R³)ₓ (I)

(R⁴)₃—Si—NH—Si(R⁴)₃ (II)

In Formula (I), R¹ is a hydrocarbon or fluorinated hydrocarbon group, R² is a hydrolyzable group, R³ is a non-hydrolyzable group, and x is an integer equal to 0, 1, or 2. In Formula (II), each R⁴ is a hydrocarbon group.

The sorbent materials can be prepared by incorporating divalent metals into a precursor material that is formed by treating a porous siliceous material with a silane and/or disilazane surface treatment agent. The porous siliceous material has mesopores. The metal-containing sorbent materials can be used to capture basic, nitrogen-containing compounds such as those having a molecular weight no greater than 150 grams/mole. This capture results in the formation of composite materials that contain incorporated metal complexes. The terms “precursor” and “precursor material” are used interchangeably. The terms “sorbent material”, “sorbent”, “metal-containing sorbent material” and “metal-containing sorbent” are used interchangeably. The terms “siliceous material” and “porous siliceous material” are used interchangeably.

By a porous material is meant a material that exhibits a BET specific surface area (measured in the absence of a divalent metal, e.g. before incorporation of a divalent metal as disclosed herein, and in the absence of any surface treatment agent) of at least about 50 m²/g. Porous materials such as porous siliceous materials and porous sorbent materials can be characterized based on the size of their pores. The term “micropores” refers to pores having a diameter less than 2 nanometers. The term “mesopores” refers to pores having a diameter in a range of 2 to 50 nanometers. The term “macropores” refers to pores having a diameter greater than 50 nanometers. The porosity of a porous material can be determined from an adsorption isotherm of an inert gas such as nitrogen or argon by the porous material under cryogenic conditions (e.g., liquid nitrogen at 77 K). The adsorption isotherm is typically obtained by measuring adsorption of the inert gas such as nitrogen or argon by the porous material at multiple relative pressures in a range of about 10⁻⁶ to about 0.99±0.01. The isotherms are then analyzed using various methods such as the BET (Brunauer-Emmett-Teller) method to calculate specific surface area and such as the Density Functional Theory (DFT) to characterize the porosity and the pore size distribution.

The term “surface area” refers to the total area of a surface of a material including the internal surfaces of accessible pores. The surface area is typically calculated from adsorption isotherms obtained by measuring the amount of an inert gas such as nitrogen or argon that adsorbs on the surface of a material under cryogenic conditions (i.e., 77 K) over a range of relative pressures. The term “BET specific surface area” is the surface area per gram of a material that is typically calculated from adsorption isotherm data of the inert gas over a relative pressure range of 0.05 to 0.3 using the BET method.

The term “divalent metal” refers to a metal having an oxidation state of +2. The divalent metal typically is from Group 2 or Groups 6 to 12 of the IUPAC Periodic Table of Elements. To avoid confusion, Group 2 has beryllium as its lightest member, Group 6 has chromium as its lightest member, Group 7 has manganese as its lightest member, Group 8 has iron as its lightest member, Group 9 has cobalt as its lightest member, Group 10 has nickel as its lightest member, Group 11 has copper as its lightest member, and Group 12 has zinc as its lightest member. The divalent metal can be in the form of a metal salt, a metal complex, a metal oxide, or the like.

Any porous siliceous material having mesopores can be reacted with the surface treatment agent to form the precursor. The porous siliceous material has mesopores (i.e., the siliceous material is mesoporous), which are pores having a diameter in a range of 2 to 50 nanometers. The average pore diameter of all the pores within the porous siliceous material is typically in the mesoporous size range (i.e., the average pore diameter is in a range of 2 to 50 nanometers). The average pore diameter is often in a range of 2 to 40 nanometers, 2 to 30 nanometers, 2 to 20 nanometers, or 2 to 10 nanometers. The method for calculating the average pore diameter is described in the Examples of U.S. Provisional Patent Application 62/269,647, entitled METAL-CONTAINING SORBENTS FOR NITROGEN-CONTAINING COMPOUNDS, which is incorporated by reference in its entirety herein.

Typically, at least 50 volume percent of the total pore volume of the porous siliceous material is attributable to mesopores. In some embodiments, at least 55 volume percent, at least 60 volume percent, at least 65 volume percent, at least 70 volume percent, at least 75 volume percent, at least 80 volume percent, at least 85 volume percent, or at least 90 volume percent of the total pore volume of the porous siliceous material is attributable to mesopores. The method for calculating the volume percent is described in the Examples section below.

The total pore volume of the porous siliceous material is often at least 0.5 cm³/gram, at least 0.6 cm³/gram, at least 0.7 cm³/gram, at least 0.8 cm³/gram, or at least 0.9 cm³/gram. The pore volume can be, for example, up to 1.5 cm³/gram or higher, up to 1.4 cm³/gram, up to 1.3 cm³/gram, up to 1.2 cm³/gram, up 1.1 cm³/gram, or up to 1.0 cm³/gram.

The specific surface area of the porous siliceous material is often at least 50 m²/gram, at least 100 m²/gram, at least 200 m²/gram, or at least 300 m²/gram. The specific surface area can be up to 1000 m²/gram or higher, up to 900 m²/gram, up to 800 m²/gram, up to 700 m²/gram, up to 600 m²/gram, or up to 500 m²/gram.

Some example porous (e.g., mesoporous) siliceous materials can be formed using a procedure similar to that described in an article by H. Bottcher et al. in Advanced Materials, Vol. 11, No. 2, 138-141 (1999). More specifically, a sol gel technique can be used to form the porous siliceous materials. A tetraalkoxy silane, a trialkoxy silane, or a mixture thereof can be hydrolyzed in the presence of an organic solvent. Some of the organic solvent can get entrapped within the sol as it is formed. The organic solvent can subsequently be removed by drying the sol resulting in the formation of a gel (e.g., a xerogel) having pores where the organic solvent previously resided.

Suitable tetraalkoxy silanes and trialkoxy silanes for preparation of the gel are often of Formula (III).

(R⁵)_{y}Si(R⁶)_{4-y} (III)

In Formula (III), R⁵ is an alkyl group or hydrogen; and R⁶ is an alkoxy or halo group. Suitable alkyl, alkoxy, and halo groups are described herein. The variable y is an integer equal to 0 or 1.

In some embodiments of Formula (III), R⁵ is an alkyl group, R⁶ is an alkoxy group or chloro, and the variable y is equal to 1. The R⁵ alkyl group and R⁶ alkoxy group often have 1 to 10 carbon atoms, 1 to 6 carbon atoms, 1 to 4 carbon atoms, or 1 to 3 carbon atoms. For example, the compounds of Formula (III) can be a trialkoxy(alkyl)silane such as trimethoxy(methyl)silane, triethoxy(methyl)silane, triethoxy(ethyl)silane, triethoxy(n-propyl)silane, triethoxy(iso-butyl)silane, tripropoxy(methyl)silane, isooctyl triethoxysilane, trimethoxysilane, triethoxysilane, or trichloromethylsilane.

In other embodiments, R⁶ is an alkoxy or chloro, and y is equal to 0 (i.e., there are no R⁵ groups). The R⁶ alkoxy group often has 1 to 10 carbon atoms, 1 to 6 carbon atoms, 1 to 4 carbon atoms, or 1 to 3 carbon atoms. For example, the compound of Formula (III) can be a tetraalkoxysilane such as tetramethoxysilane, tetraethoxysilane, tetrapropoxysilane, or silicon tetrachloride.

The various R groups presented herein e.g. in Formulas (I), (II) and (III), and associated terms such as alkyl, alkoxy, aryl, hydrolyzable, and so on, are defined and described in further detail in U.S. Provisional Patent Application 62/269,647, entitled METAL-CONTAINING SORBENTS FOR NITROGEN-CONTAINING COMPOUNDS, the relevant sections of which are incorporated by reference at this location herein for this specific purpose.

The compound of Formula (III) is initially mixed with an organic solvent. The organic solvent is typically selected to be miscible with (i.e., to dissolve) the compound of Formula (III) and to be easily removed from the sol by drying. Example organic solvents include, but are not limited to, alcohols of lower alkanols (e.g., ethanol, methanol, propanol, isopropanol, butanol, sec-butyl alcohol, tert-butyl alcohol, amyl alcohol, hexyl alcohol, methoxy propanol and 2-ethyl alcohol), ketones (e.g., acetone, methyl ethyl ketone, methyl isobutyl ketone, methyl amyl ketone, and methyl n-butyl ketone), esters (e.g. butyl acetate, 2-ethoxyethyl acetate and 2-ethylhexyl acetate), and ethers (e.g., tetrahydrofuran, ethylene glycol monoethyl ether, ethylene glycol monobutyl ether, ethylene glycol dibutyl ether, propylene glycol monomethyl ether, diethylene glycol monobutyl ether, diethylene glycol dibutyl ether, dipropylene glycol monoethyl ether, and dipropylene glycol monobutyl ether).

The mixture of the compound of Formula (III) and the organic solvent usually has a pH adjusted to be in a range of 2 to 4. Although any suitable acid can be used, the acid is often a mineral acid such as, for example, hydrochloric acid, nitric acid, phosphoric acid, or sulfuric acid. The acid is typically diluted with water prior to adjusting the pH of the mixture.

The amount of organic solvent included in the mixture (e.g., the mixture of the compound Formula (III), the dilute acid, and organic solvent) can influence the pore volume of the porous siliceous material that is formed. That is, a larger volume of the organic solvent in the mixture tends to lead to higher pore volumes in the porous siliceous material. The mixture often includes at least 20 volume percent organic solvent. In some embodiments, the amount of the organic solvent is at least 30 volume percent, at least 40 volume percent, or at least 50 volume percent of the mixture. The upper limit is often 90 volume percent. If the volume percent is higher, the amount of porous siliceous material formed may be undesirably low. The volume percent of the organic solvent in the mixture can be up to 85 volume percent, up to 80 volume percent, up to 75 volume percent, up to 70 volume percent, up to 65 volume percent, up to 60 volume percent, or up to 55 volume percent.

After aging the mixture for several hours, the pH is increased to 7 or greater. Any suitable base (e.g., dilute ammonium hydroxide or an amine that is soluble in the mixture) can be used. The addition of the base results in the hydrolysis of the compound of Formula (III) and the formation of a gel. That is, a three-dimensional network is formed that is connected together through —O—Si—O— linkages. The gel often forms within minutes of adding the base. The resulting gel can be collected (e.g., by filtration).

The gel is then dried to remove the organic solvent from the gel. Typically, the drying temperature is selected for effective removal of the organic solvent. Removal of the organic solvent leads to pores within the siliceous material. The drying temperature is often selected to be higher than the boiling point of the organic solvent. In some embodiments, the drying temperature is selected to be at least 10° C. higher, at least 20° C. higher, or at least 30° C. higher than the boiling point of the organic solvent. Often, the drying temperature is set at a first temperature to remove most of the organic solvent and then at a second higher temperature to remove any residual water. The drying temperature of either step can be, for example, up to 150° C., up to 140° C., up to 130° C., up to 120° C., up to 110° C., or up to 100° C.

Other example porous siliceous materials can be formed by mixing an aqueous metal silicate (e.g., aqueous sodium silicate) with an acid (e.g., sulfuric acid), precipitating the sodium salt, bringing the mixture to an alkaline pH, and aging for a time sufficient to form a gel in the presence of a porogen (e.g. an organic solvent). This preparation method is further described, for example, in U.S. Pat. No. 7,559,981 B2 (Friday et al.).

A further example of a porous siliceous material could be prepared from a colloidal silica sol such as those having an average particle size in the range of 2 to 50 nanometers. The sols can be either acid or base stabilized. Such silica sols are commercially available from Nalco Company (Naperville, Ill., USA) and include, for example, NALCO 2326 and NALCO 2327. The pH of the sol can be adjusted to be within the range of 5 to 8 by the addition of an acid or base. This pH adjustment results in the destabilization and subsequent aggregation of the silica particles. The aggregated silica particles can be collected and dried.

Various types of mesoporous siliceous materials are commercially available. Some of the siliceous materials have a regular arrangement of mesopores. Examples include MCM-41 (i.e., Mobile Composition of Matter No. 41) and MCM-48 (i.e., Mobile Composition of Matter No. 48), which refer to siliceous materials that were developed by researchers at Mobil Oil Corporation. Another example is SBA-15 (i.e., Santa Barbara Amorphous No. 15), which refers to a siliceous material that was developed by researchers at the University of California, Santa Barbara. Yet another example is M41S, which refers to a siliceous material that was developed by researchers at ExxonMobil. At least MCM-41 and SBA-15 are available from Sigma-Aldrich (Saint Louis, Mo., USA).

Other porous siliceous materials (e.g., silica gels) are commercially available, for example, under the trade designation DAVISIL from W. R. Grace and Company (Columbia, Md., USA). Porous siliceous materials are available, for example, having an average pore diameter of 6 nanometers (DAVISIL LC60A), 15 nanometers (DAVISIL LC150A), 25 nanometers (DAVISIL LC250A), and 50 nanometers (DAVISIL LC500A). Still other porous siliceous materials include silica gels commercially available from Material Harvest Limited (Cambridge, England), from SiliCycle Inc. (Quebec City, Canada), and from EMD Millipore (Darmstadt, Germany) under the trade designation LICHROPREP.

In some embodiments, an acid-base indicator can be added to the porous siliceous material, e.g. prior to, during, or after, reaction with the surface treatment agent to form the precursor material. That is, both the later formed precursor material and sorbent can include the acid-base indicator. The acid-base colorimetric indicator is a compound (typically an organic dye) that changes color when it undergoes a transition from being in an acidic form to being in a basic form. The acid-base colorimetric indicator is typically selected to have a pK_{b} that is less than a pK_{b} of the nitrogen-containing compound that will be sorbed on the sorbent material. That is, the acid-base colorimetric indicator is selected to change from a first color to a second color when all or a significant portion of the capacity of the sorbent for sorption of a nitrogen-containing compound has been reached or is close to being reached. As used herein, the term “close to being reached” means that at least 60 percent or more of the capacity has been reached (i.e., a least 60 percent or more of the available sorption sites have been used for sorption of the nitrogen-containing compound). For example, at least 70 percent, at least 80 percent, at least 90 percent, or at least 95 percent of the sorption sites have been used for sorption of the nitrogen-containing compound.

Knowing the pK_{b} of the nitrogen-containing compound that is to be sorbed, one of skill in the art can readily select an acid-base colorimetric indicator that has a lower pK_{b} value. In some applications, the difference between the pK_{b} value of the nitrogen-containing compound and the pK_{b} of the acid-base colorimetric indicator is at least 1, at least 2, at least 3, or at least 4. The pK_{b} of the acid-base colorimetric indicator is often in a range of 3 to 10.

Example acid-base colorimetric indicators include, but are not limited to, methyl red, bromoxylenol blue, pararosaniline, chrysoidine, thymol blue, methyl yellow, bromophenyl blue, Congo red, methyl orange, bromocresol green, azolitmin, bromocresol purple, bromothymol blue, phenol red, neutral red, naphtholphthalein, cresol red, phenolphthalein, and thymolphthalein.

The acid-base colorimetric indicators can be added to the porous siliceous material using any suitable method. In some embodiments, the porous siliceous material is soaked in a solution of the acid-base colorimetric indicator for at least 10 minutes, at least 20 minutes, at least 30 minutes, at least 1 hour, at least 2 hours, at least 4 hours, or at least 8 hours. Often, the soaking solution contains about 1 milligram of acid-base indicator per gram of the porous siliceous material.

The porous siliceous material is reacted with a surface treatment agent. The surface treatment agent is a silane of Formula (I), a disilazane of Formula (II), or a mixture of the silane of Formula (I) and the disilizane of Formula (II).

R¹—Si(R²)₃₋ₓ(R³)ₓ (I)

(R⁴)₃—Si—NH—Si(R⁴)₃ (II)

In Formula (I), R¹ is a hydrocarbon or fluorinated hydrocarbon group, R² is a hydrolyzable group, R³ is a non-hydrolyzable group, and x is an integer equal to 0, 1, or 2. In Formula (II), each R⁴ is a hydrocarbon group. The surface treatment agent is typically one or more compounds of Formula (I), one or more compounds or Formula (II), or a mixture of one or more compounds of Formula (I) plus one of more compounds of Formula (II). At least in some embodiments, if more than one surface treatment agent is used, the multiple surface treatment agents often are of Formula (I).

Group R¹ in Formula (I) is a hydrocarbon or fluorinated hydrocarbon group. This group often provides or enhances the hydrophobic character of the surface of the precursor that is formed by reacting the compound of Formula (I) with the porous siliceous material. As used herein, the term “hydrocarbon” refers to a group that includes only carbon and hydrogen atoms. As used herein, the term “fluorinated hydrocarbon” refers to a group in which at least one hydrogen atom of a hydrocarbon group has been replaced with a fluorine atom. A hydrocarbon group or a fluorinated hydrocarbon group can be saturated, partially unsaturated, or unsaturated (e.g., aromatic). Suitable hydrocarbon groups are monovalent and include, for example, alkyl groups, aryl groups, aralkyl groups, and alkaryl groups. Suitable fluorinated hydrocarbon groups are monovalent and include, for example, fluorinated alkyl groups (i.e., alkyl groups substituted with one or more fluoro groups), fluorinated aryl groups (i.e., aryl groups substituted with one or more fluoro groups), fluorinated aralkyl groups (i.e., aralkyl groups substituted with one or more fluoro groups), and fluorinated alkaryl groups (i.e., alkaryl groups substituted with one or more fluoro groups). In many embodiments, R¹ is an alkyl, fluorinated alkyl, aryl, fluorinated aryl, aralkyl, fluorinated aralkyl, alkaryl, or fluorinated alkaryl. In most embodiments, the hydrocarbon or fluorinated hydrocarbon group does not react with the surface of the porous siliceous material, with the divalent metal, or with the nitrogen-containing compound.

Group R² in Formula (I) is a hydrolyzable group. The hydrolyzable group is the reaction site of the surface treatment agent with the porous siliceous material (e.g., with hydroxyl groups on the surface of the porous siliceous material). When the hydrolyzable group reacts with the surface of the porous siliceous material, —O—Si—O— bonds are formed attaching the surface treatment agent to the porous siliceous material. The hydrolyzable groups can be an alkoxy, aryloxy, alkaryloxy, aralkoxy, acyloxy, or halo. These groups are the same as described above. In many embodiments, R² is alkoxy or halo.

Group R³ in Formula (I) is a non-hydrolyzable group. Typical non-hydrolyzable groups include, but are not limited to, hydrogen, alkyl, aryl, alkaryl, and aralkyl. These groups are the same as described above. In many embodiments, R³ is hydrogen, an alkyl, or is absent (x is equal to 0).

In some embodiments of Formula (I), R¹ is an alkyl, fluorinated alkyl, aryl, fluorinated aryl, aralkyl, fluorinated aralkyl, alkaryl, or fluorinated alkaryl; each R² is alkoxy or halo; and x is equal to 0 (R³ is absent). Often, alkoxy R² groups have 1 to 10 carbon atoms, 1 to 6 carbon atoms, 1 to 4 carbon atoms, or 1 to 3 carbon atoms and halo R² groups are chloro. Examples include, but are not limited to, trimethoxy(methyl)silane, trimethoxy(3,3,3-trifluoropropyl)silane, trimethoxy(propyl)silane, trimethoxy (isobutyl)silane, triethoxy(methyl)silane, triethoxy(ethyl)silane, trimethoxy(phenyl)silane, tripropoxy(methyl)silane, trimethoxy(2-phenylethyl)silane, triethoxy(cyclopentyl)silane, trimethoxy(isooctyl)silane, triethoxy(pentafluorophenyl)silane, triethoxy(phenyl)silane, triethoxy(p-tolylsilane), triethoxy(1H,1H,2H,2H-perfluorooctyl)silane, triethoxy(dodecyl)silane, trimethoxy(hexadecyl)silane, and triethoxy(n-octadecyl)silane, methylchlorosilane, ethyltrichlorosilane, butyltrichlorosilane, trichloro(octyl)silane, and trichlorophenylsilane.

In other embodiments of Formula (I), R¹ is an alkyl, fluorinated alkyl, aryl, fluorinated aryl, aralkyl, fluorinated aralkyl, alkaryl, or fluorinated alkaryl; each R² is alkoxy or halo; each R³ is independently hydrogen or alkyl; and x is equal to 1 or 2. Often, alkoxy R² groups have 1 to 10 carbon atoms, 1 to 6 carbon atoms, 1 to 4 carbon atoms, or 1 to 3 carbon atoms and halo R² groups are chloro. Further, alkyl R³ groups often have 1 to 10 carbon atoms, 1 to 6 carbon atoms, 1 to 4 carbon atoms, or 1 to 3 carbon atoms.

Examples of Formula (I) where R¹ is an alkyl or aryl, R² is halo or alkoxy, and each R³ is independently hydrogen or methyl include, but are not limited to, dichloromethylsilane, chlorodimethylsilane, methyldiethoxysilane, diethoxy(methyl)phenylsilane, dimethoxy(methyl)octylsilane, and chlorophenylsilane.

A surface treatment agent of Formula (II) can be used in place of or combination with the surface treatment agent of Formula (I). In Formula (II), each R⁴ group is a hydrocarbon group. Suitable hydrocarbon groups are monovalent and include, for example, alkyl groups, aryl groups, aralkyl groups, and alkaryl groups. These groups are the same as described above.

In many embodiments of the surface treatment agent of Formula (II), each R⁴ group is an alkyl. In some specific embodiments, each R⁴ group has 1 to 10 carbon atoms, 1 to 6 carbon atoms, 1 to 4 carbon atoms, or 1 to 3 carbon atoms. For example, the compound of Formula (II) is hexamethylsilazane, with R⁴ being methyl.

In many embodiments, the only surface treatment agents used are those of Formula (I) and/or Formula (II). There are no surface treatment agents that lack a hydrophobic group such as R¹ in Formula (I) and R⁴ in Formula (II). That is, there is no surface treatment agent used that would replace R¹ or R⁴ with a hydrophilic group or a reactive functional group such as an alkyl that is substituted with a primary amino group.

The surface treatment agent can be added to the porous siliceous material using any known method. In some methods, the porous siliceous material is dispersed in an aqueous solution. The surface treatment agent is dissolved in an organic solvent that is miscible with water and then added slowly to the dispersion. The reaction of the surface treatment agent with the porous siliceous material can be done under acidic conditions (such as in a pH range of 1 to 5) or under basic conditions (such as in a pH range of 9 to 12). Hydrolysis of the surface treatment agent allows reaction with hydroxyl groups on the surface of the porous siliceous material. This reaction results in the formation of —O—Si—O— linkages between the surface of the porous siliceous material and the surface treatment agent. That is, the surface treatment agent is covalently bound to the surface of the porous siliceous material. The resulting material, which is referred to as the precursor material, tends to have a more hydrophobic surface than the porous siliceous material prior to reaction with the surface treatment agent. Stated differently, the surface treatment agent is typically added to impart hydrophobic character or to enhance the hydrophobic character of the precursor.

While in some embodiments the surface treatment agent may be conveniently added to the porous siliceous material after formation of the porous siliceous material, it will be appreciated based on the discussions herein that the surface treatment agent may be added at any suitable stage in the preparation of the porous siliceous material. For example, in some embodiments the surface treatment agent may be added to a mixture that is used to prepare the porous siliceous material. In similar manner, an acid-base colorimetric indicator as discussed previously herein may be added at any suitable stage of the preparation of the surface-treated, porous siliceous material.

The surface treatment agent is typically added in an amount that is in a range of 0.1 to 4.5 mmoles per gram of the porous siliceous material. If the amount of the surface treatment agent is less than 0.1 mmole per gram of the porous siliceous material, the precursor may not be sufficiently hydrophobic. The hydrophobicity tends to increase the ability of the sorbent material to sorb basic, nitrogen-containing compounds. In some embodiments, the amount of the surface treatment agent is added in an amount equal at least 0.2 mmoles per gram, at least 0.3 mmoles per gram, at least 0.5 mmoles per gram, or at least 1 mmole per gram of the porous siliceous material. The amount of the surface treatment agent (e.g., the surface treatment agent minus the groups that are given off in the condensation reaction) is typically selected to provide no greater than a monolayer to the surface of the porous siliceous material. The ability of the sorbent material to sorb basic, nitrogen-containing compounds tends to decrease when more than a monolayer of the surface treatment agent is added. In some embodiments, the amount of added surface treatment agent can be up to 4.5 mmoles per gram, up to 4.0 mmoles per gram, up to 3.5 mmoles per gram, up to 3.0 mmoles per gram, up to 2.5 mmoles per gram, or up to 2 mmoles per gram of the porous siliceous material.

The reaction to form the precursor material can occur at room temperature or at an elevated temperature (i.e., at a temperature greater than room temperature). In some embodiments, the reaction temperature is at least 30° C., at least 40° C., at least 50° C., at least 60° C., or at least 70° C. The temperature is usually selected so that the water and organic solvent included in the mixture are not removed by boiling during the reaction period. The reaction period can be for any time sufficient to form the precursor material. In some embodiments, the reaction temperature is held at 75° C. for up to 24 hours, up to 20 hours, up to 16 hours, up to 8 hours, up to 4 hours, up to 2 hours, or up to 1 hour.

After formation of the precursor, a divalent metal is incorporated into the precursor to form the metal-containing sorbent material. The divalent metal is typically incorporated by treating the precursor with a metal salt. Any known procedure for adding the divalent metal to the precursor can be used. In many embodiments, a metal salt or a solution of a metal salt (e.g., a metal salt dissolved in water) is added to the precursor prior to removal of the organic solvent and/or water present during the surface modification process (i.e., the process to react the surface treatment agent with the porous siliceous material). This mixture is often stirred for several hours to allow sufficient time for impregnation of the divalent metal into the precursor. The mixing time of the metal salt with the precursor material is often up to 1 hour, up to 2 hours, up to 4 hours, up to 8 hours, up to 16 hours, up to 24 hours, or up to 48 hours. The mixing temperature can be at room temperature or above. The resulting sorbent material can then be separated from the organic solvent and/or water by filtration. The sorbent can be dried at a temperature sufficient to remove any remaining water and/or organic solvent. For example, the sorbent can be dried at temperatures in a range of 80° C. to 150° C.

The metal salt incorporated into the precursor material contains a cation that is the divalent metal (i.e., a metal with a +2 oxidation state) and one or more anions to balance the charge. Suitable metal ions (divalent metals) are typically from Group 2 or Groups 6 to 12 of the periodic table. Example divalent metals include, but are not limited to, chromium, nickel, cobalt, copper, zinc, manganese, cadmium, iron, magnesium, calcium, barium, or a mixture thereof. In many embodiments, the divalent metal is a Group 6 to 12 metal such as, for example, chromium, nickel, cobalt, copper, zinc, iron, or a mixture thereof. In some particular embodiments, the divalent metal is copper, cobalt, zinc, or nickel. In some even more particular embodiments, the divalent metal is zinc or copper.

The metal salts are typically selected from those that are soluble in water and/or an organic solvent that is miscible with water. The anion of the metal salt is often a halide (e.g., chloride), nitrate, sulfate, carboxylate (e.g., acetate, formate, and propanoate), or halogen-substituted carboxylates (e.g., chloroacetate, dichloroacetate, and chloro-substituted propanoate). In many embodiments, the anion is chloride, acetate, or nitrate.

Examples of specific metal salts include, but are not limited to, zinc acetate, copper acetate, nickel acetate, cobalt acetate, iron acetate, manganese acetate, chromium acetate, cadmium acetate, zinc formate, copper formate, nickel formate, cobalt formate, iron formate, manganese formate, cadmium formate, zinc propanoate, copper propanoate, nickel propanoate, cobalt propanoate, iron propanoate, manganese propanoate, cadmium propanoate, zinc chloroacetate, copper chloroacetate, nickel chloroacetate, cobalt chloroacetate, iron chloroacetate, manganese chloroacetate, cadmium chloroacetate, zinc dichloroacetate, copper dichloroacetate, nickel dichloroacetate, cobalt dichloroacetate, iron dichloroacetate, manganese dichloroacetate, cadmium dichloroacetate, zinc chloride, copper chloride, nickel chloride, cobalt chloride, iron chloride, manganese chloride, cadmium chloride, chromium chloride, magnesium chloride, zinc sulfate, copper sulfate, nickel sulfate, cobalt sulfate, iron sulfate, manganese sulfate, cadmium sulfate, zinc nitrate, copper nitrate, nickel nitrate, cobalt nitrate, iron nitrate, and the like.

The amount of the divalent metal added to the precursor is typically at least 1 weight percent based on the weight of the sorbent material. If the amount is lower than 1 weight percent, the resulting sorbent material may have an undesirably low capacity for sorbing nitrogen-containing compounds. The amount of the divalent metal can be at least 2 weight percent, at least 3 weight percent, at least 4 weight percent, or at least 5 weight percent based on the weight of the sorbent material. The divalent metal can be included in an amount up to 50 weight percent. If the amount is greater than about 50 weight percent, the resulting sorbent material may have an undesirably low capacity for sorbing nitrogen-containing compounds. For example, the amount can be up to 45 weight percent, up to 40 weight percent, up to 35 weight percent, up to 30 weight percent, up to 25 weight percent, or up to 20 weight percent based on the weight of the sorbent material. For example, the amount is often in a range of 1 to 50 weight percent, 1 to 40 weight percent, 1 to 30 weight percent, 1 to 20 weight percent, 5 to 50 weight percent, 5 to 40 weight percent, 5 to 30 weight percent, 5 to 25 weight percent, 5 to 20 weight percent, 10 to 50 weight percent, 10 to 40 weight percent, 10 to 30 weight percent, 10 to 25 weight percent, 10 to 20 weight percent, 15 to 50 weight percent, 15 to 40 weight percent, 15 to 30 weight percent, or 15 to 25 weight percent based on the weight of the sorbent material.

In some embodiments such as with zinc-containing, cobalt-containing, nickel-containing, and magnesium-containing sorbent materials, the divalent metal may be present as an ionic species. For a divalent metal that is ionic, a crystalline phase that includes the metal species usually cannot be detected when the metal-containing sorbent materials are analyzed using x-ray diffraction. In other embodiments such as with copper-containing sorbent materials, the divalent metal may be present as an oxide. For metal oxides, a crystalline phase may be detected when the metal-containing sorbent materials are analyzed using x-ray diffraction.

A method of preparing a filter support comprising the metal-containing sorbent is also provided. More specifically, the method includes providing a porous siliceous material having mesopores. The method further includes treating the porous siliceous material with a surface treatment agent to form a precursor, wherein treating includes adding 0.1 to 4.5 mmoles of the surface treatment agent per gram of the porous siliceous material. The surface treatment agent is a silane of Formula (I), a disilazane of Formula (II), or a mixture of the silane of Formula (I) and the disilizane of Formula (II).

R¹—Si(R²)₃₋ₓ(R³)ₓ (I)

(R⁴)₃—Si—NH—Si(R⁴)₃ (II)

In Formula (I), R¹ is a hydrocarbon or fluorinated hydrocarbon group, R² is a hydrolyzable group, R³ is a non-hydrolyzable group, and x is an integer equal to 0, 1, or 2. In Formula (II), each R⁴ is a hydrocarbon group. The method yet further includes incorporating a divalent metal into the precursor in an amount equal to at least 1 weight percent based on the total weight of the sorbent to form the metal-containing sorbent. The method further includes supporting the thus-formed metal-containing sorbent particles on a filter support.

The metal-containing sorbent material, as supported on a filter support of any suitable design and character, can be used to capture vapors of basic, nitrogen-containing compounds. Thus, a method of capturing a basic, nitrogen-containing compound is provided. The method includes providing the metal-containing sorbent as described above and then exposing the metal-containing sorbent to vapors of the basic, nitrogen-containing compound. A metal complex is formed. The metal complex includes the reaction product of the divalent metal as defined above and at least one nitrogen-containing compound.

The basic nitrogen-containing compounds that react with the divalent metal to form a metal complex can be classified as Lewis bases, Bronsted-Lowry bases, or both. Suitable basic nitrogen-containing compounds often have a low molecular weight (e.g., no greater than 150 grams/mole). That is, the basic, nitrogen-containing compounds can be volatile at or near room temperature or can be volatile under conditions of use. Examples of basic, nitrogen-containing compounds include, but are not limited to, ammonia, hydrazine compounds, amine compounds (e.g., alkyl amines, dialkylamines, triaalkylamines, alkanolamines, alkylene diamines, arylamines), and nitrogen-containing heterocyclic (saturated and unsaturated) compounds. Specific basic nitrogen-containing compounds include, for example, ammonia, hydrazine, methylhydrazine, methylamine, dimethylamine, trimethylamine, ethylamine, diethylamine, triethylamine, propylamine, dipropylamine, tripropylamine, isopropylamine, diisopropylamine, triisopropylamine, ethanolamine, cyclohexylamine, morpholine, pyridine, benzylamine, phenylhydrazine, ethylene diamine, and 1,3-propane diamine.

After exposure to vapors of the basic, nitrogen-containing compound, the metal-containing sorbent material (as supported on a filter support) is converted into a metal complex-containing composite material. That is, in another aspect, a method of forming a metal complex-containing composite material is provided. The metal complex containing composite material is a reaction product of the metal-containing sorbent material and a basic, nitrogen-containing compound. Alternatively, the metal complex-containing composite material can be considered to contain a) a precursor material and b) a metal complex incorporated into the precursor material. The metal complex includes a reaction product of a divalent metal and at least one basic, nitrogen-containing compound.

In many embodiments of the metal complex-containing composite material, divalent metal incorporated into the precursor material remains that has not been converted to a metal complex. Stated differently, only some of the divalent metal in the sorbent material has reacted with a basic, nitrogen-containing compound to form a metal complex. The metal complex-containing composite material includes a mixture of divalent metal that is not complexed with the basic, nitrogen-containing compound and divalent metal that is complexed with at least one basic, nitrogen-containing compound. The total amount of divalent metal (whether it is complexed or not with the basic, nitrogen-containing compound) in the composite material is at least 1 weight percent based on a total weight of the composite material.

The total amount of the divalent metal in the composite material can be at least 2 weight percent, at least 3 weight percent, at least 4 weight percent, or at least 5 weight percent based on the total weight of the composite material. The total divalent metal can be included in an amount up to 50 weight percent. For example, the amount can be up to 45 weight percent, up to 40 weight percent, up to 35 weight percent, up to 30 weight percent, up to 25 weight percent, or up to 20 weight percent based on the total weight of the composite material. For example, the amount is often in a range of 1 to 50 weight percent, 1 to 40 weight percent, 1 to 30 weight percent, 1 to 20 weight percent, 5 to 50 weight percent, 5 to 40 weight percent, 5 to 30 weight percent, 5 to 25 weight percent, 5 to 20 weight percent, 10 to 50 weight percent, 10 to 40 weight percent, 10 to 30 weight percent, 10 to 25 weight percent, 10 to 20 weight percent, 15 to 50 weight percent, 15 to 40 weight percent, 15 to 30 weight percent, or 15 to 25 weight percent based on the total weight of the composite material.

Any portion of the total divalent metal in the composite material can be in the form of the metal complex. For example, at least 1 weight percent, at least 5 weight percent, at least 10 weight percent, or at least 20 weight percent and up to 100 weight percent, up to 90 weight percent, up to 80 weight percent, up to 70 weight percent, up to 60 weight percent, or up to 50 weight percent of the total divalent metal may be present as a metal complex in the composite.

The maximum amount of basic, nitrogen-containing compounds sorbed (e.g., complexed) by the metal-containing sorbent material is related to the amount of divalent metal incorporated into the sorbent material. The maximum amount of basic, nitrogen-containing compound sorbed is often at least 1.5 mmoles per gram of metal-containing sorbent material (i.e., 1.5 mmoles of the sorbed basic, nitrogen-containing compound per gram of metal-containing sorbent material) and can be up to 10 mmoles per gram or even higher. In many embodiments, the maximum amount sorbed is at least 2 mmoles per gram, 2.5 mmoles per gram, or at least 3 mmoles per gram. The amount sorbed can be, for example, up to 9 mmoles per gram, up to 8 mmoles per gram, up to 7 mmoles per gram, up to 6 mmoles per gram, or up to 5 mmoles per gram.

The porosity of the sorbent material (which is controlled predominately by the porosity of the porous siliceous material used to form the precursor) also affects the capacity of the metal-containing sorbent material for sorption of basic, nitrogen-containing compounds. Typically, sorbent materials with higher porosity have greater accessibility to functional group sites. Higher porosity sorbent materials, probably due to the presence of mesopores and/or micropores in the sorbent material, typically lead to higher incorporation of divalent metal. Higher incorporation of divalent metal (at least up the point where clustering and/or layering occurs) results in more coordination sites available for sorption of the basic, nitrogen-containing compounds. The porosity and BET specific surface area of the sorbent material can be altered by selection of the porous siliceous material or the method used to prepare the porous siliceous material.

In some embodiments, a color change occurs upon exposure to a basic, nitrogen-containing compound. This color change can occur, for example, when the divalent metal is either copper or nickel and/or when an acid-base indicator dye is included in the sorbent. A sorbent containing copper can change from a darkish gray color to a turquoise color and nickel can change from a tan color to an olive green color. A sorbent containing an acid-base indicator dye can also change color when the sorption capacity of the sorbent is reached or is close to being reached.

Metal-containing sorbent particles that may be suitable for being supported on a filter support, methods of making such materials, and methods of using such materials to capture basic, nitrogen-containing compounds are described in detail U.S. Provisional Patent Application 62/269,647, entitled METAL-CONTAINING SORBENTS FOR NITROGEN-CONTAINING COMPOUNDS, which is incorporated by reference in its entirety herein. In some embodiments, sorbent particles that are supported on a filter support as disclosed herein may comprise a binder. Such approaches and arrangements are described in detail in U.S. Provisional Patent Application No. 62/421,584, Attorney Docket Number 78842US002, and entitled Composite Granules Including Metal-Containing Polymeric Materials, which is incorporated by reference herein in its entirety.

### List of Exemplary Embodiments

Embodiment 1 is an air filter comprising a filter support that supports metal-containing sorbent particles, wherein at least some of the sorbent particles comprise: a) a precursor comprising a reaction product of a mixture comprising 1) a porous siliceous material having mesopores; and 2) a surface treatment agent in an amount in a range of 0.1 to 4.5 mmoles per gram of the porous siliceous material, the surface treatment agent comprising: (a) a silane of Formula (I): R¹—Si(R²)₃₋ₓ(R³)ₓ (I), wherein R¹ is a hydrocarbon or fluorinated hydrocarbon group; R² is a hydrolyzable group; R³ is a non-hydrolyzable group; x in an integer equal to 0, 1, or 2; or (b) a disilazane of Formula (II): (R⁴)₃—Si—NH—Si(R⁴)₃ (II), wherein each R⁴ is a hydrocarbon group; or (c) a mixture of the silane of Formula (I) and the disilazane of Formula (II); and b) a divalent metal incorporated into the precursor in an amount equal to at least 1 weight percent based on the total weight of the sorbent particles.

Embodiment 2 is the air filter of embodiment 1 wherein the filter support comprises a substrate with at least one major surface with at least some of the sorbent particles disposed thereon. Embodiment 3 is the air filter of embodiment 2 wherein the sorbent particles are present substantially as a monolayer on the major surface of the substrate. Embodiment 4 is the air filter of embodiment 1 wherein the filter support comprises a porous, air-permeable material with the sorbent particles disposed on a major surface thereof and/or with the sorbent particles disposed within the interior of the material at least in a location proximate the major surface of the material. Embodiment 5 is the air filter of embodiment 4 wherein the sorbent particles are disposed throughout the interior of the porous, air-permeable material. Embodiment 6 is the air filter of any of embodiments 1-5 wherein the air filter consists essentially of the filter support.

Embodiment 7 is the air filter of any of embodiments 1-6 wherein the filter support comprises a sheet-like material that exhibits a major plane and that exhibits a thickness of less than about 3 mm and that is configured to allow airflow through the filter support at least in a direction at least generally perpendicular to the major plane of the sheet-like material.

Embodiment 8 is the air filter of any of embodiments 1-4 and 6-7 wherein the filter support comprises a netting with a major surface with the sorbent particles adhesively attached thereto.

Embodiment 9 is the air filter of any of embodiments 1-7 wherein the filter support comprises a fibrous web that exhibits an interior and wherein the sorbent particles are disposed within at least portions of the interior of the web. Embodiment 10 is the air filter of embodiment 9 wherein the sorbent particles are disposed throughout an interior of the fibrous web. Embodiment 11 is the air filter of embodiment 9 wherein the web is a nonwoven fibrous web. Embodiment 12 is the air filter of embodiment 11 wherein the nonwoven fibrous web is a meltblown web. Embodiment 13 is the air filter of any of embodiments 9-12 wherein at least some fibers of the fibrous web are each bonded to at least one of the sorbent particles.

Embodiment 14 is the air filter of any of embodiments 1-5 and 7-13 wherein the filter support is one layer of a multilayer, air-permeable assembly. Embodiment 15 is the air filter of embodiment 14 wherein the multilayer air-permeable assembly includes at least one layer that is not the same layer as the filter support and that is a particle-filtration layer exhibiting a Percent Penetration of less than 50. Embodiment 16 is the air filter of embodiment 15 wherein the particle-filtration layer comprises electret moities.

Embodiment 17 is the air filter of any of embodiments 1-14 wherein the filter support is a filter media that exhibits a Percent Penetration of less than 50.

Embodiment 18 is the air filter of any of embodiments 1-17 wherein the filter support is pleated.

Embodiment 19 is the air filter of any of embodiments 1-18 wherein the air filter is a framed air filter that is configured to be inserted into an air filter receptacle of an air-handling apparatus chosen from the group consisting of a forced air heating unit, a forced air cooling unit, a forced-air heating/cooling unit, a room air purifier, and a cabin air filtration unit for a motor vehicle.

Embodiment 20 is the air filter of any of embodiments 1, 6, 14-16, and 19 wherein the filter support comprises a honeycomb with through-apertures within which the sorbent particles are disposed.

Embodiment 21 is the air filter of any of embodiments 1-5 and 7-18 wherein the filter support provides a layer of a filtering face-piece respirator. Embodiment 22 is the air filter of embodiment 21 wherein the filtering face-piece respirator is chosen from the group consisting of flat-fold respirators and molded respirators.

Embodiment 23 is the air filter of any of embodiments 1 and 6 wherein the filter support comprises a container with an interior within which the sorbent particles are disposed, and with at least one air inlet and at least one air outlet. Embodiment 24 is the air filter of embodiment 23 wherein the filter support comprises a filter cartridge. Embodiment 25 is the air filter of embodiment 24 wherein the filter cartridge is configured to be used with a personal protection device chosen from the group consisting of half-face negative-pressure respirators, full-face negative-pressure respirators, escape hoods, and powered air-purifying respirators.

Embodiment 26 is a method of capturing at least some of a basic, nitrogen-containing compounds having a molecular weight no greater than 150 grams/mole from air, the method comprising: positioning the air filter of any of embodiments 1-25 so that the sorbent particles are exposed to the air; and, sorbing at least some of the basic, nitrogen-containing compound onto the sorbent particles.

Embodiment 27 is the method of embodiment 26, wherein the filter support exhibits a major surface and wherein the air is present in the form of an airstream moving in a direction that is at least generally aligned with a plane of the major surface of the filter support.

Embodiment 28 is the method of embodiment 26 wherein the filter support allows airflow there through and wherein the air is present in the form of an airstream that passes through at least a portion the filter support in a direction at least generally perpendicular to a major surface of the filter support.

Embodiment 29 is a method of making an air filter comprising a filter support that comprises metal-containing sorbent particles, the method comprising: a) providing a porous siliceous material having mesopores; b) treating the porous siliceous material with a surface treatment agent to form a precursor, wherein treating comprises adding 0.1 to 4.5 mmoles of the surface treatment agent per gram of the porous siliceous material, the surface treatment agent comprising 1) a silane of Formula (I): R¹—Si(R²)₃₋ₓ(R³)ₓ (I), wherein R¹ is a hydrocarbon or fluorinated hydrocarbon group; R² is a hydrolyzable group; R³ is a non-hydrolyzable group; x is an integer equal to 0, 1, or 2; or, 2) a disilazane of Formula (II) (R⁴)₃—Si—NH—Si(R⁴)₃ (II), wherein each R⁴ is a hydrocarbon group; or, 3) a mixture of the silane of Formula (I) and the disilazane of Formula (II); and c) incorporating a divalent metal into the precursor to form the metal-containing sorbent particles, wherein the divalent metal is incorporated in an amount equal to at least 1 weight percent based on the total weight of the sorbent particles; and, d) supporting the metal-containing sorbent particles on a filter support.

### EXAMPLES

### List of Materials

| Chemical Name | Chemical Supplier |
|---|---|
| Aqueous boric acid solution | Sigma-Aldrich, Milwaukee, WI |
| (4 weight %) | |
| Bromocresol green | Sigma-Aldrich, Milwaukee, WI |
| Aqueous hydrogen chloride | Sigma-Aldrich, Milwaukee, WI |
| solution (0.1 M) | |
| Tetraethyl orthosilicate | Sigma-Aldrich, Milwaukee, WI |
| Ethanol | EMD Millipore, Darmstadt, |
| | Germany |
| Ammonium hydroxide | EMD Millipore, Darmstadt, |
| (28 wt % in H₂0) | Germany |
| Isooctyltrimethoxysilane | Gelest, Morrisville, PA |
| Zinc (II) chloride (ZnCl₂), | Alfa Aesar, Ward Hill, MA |
| anhydrous, 99.99% | |

### Procedures

### Analysis and Characterization Procedures

Porosity and gas sorption experiments were performed using a Quantachrome Autosorb iQ Automated Surface Area and Pore Size Analyzer using adsorbates of ultra-high purity nitrogen. The software ASiQWin was used for data acquisition and analysis. The following method was followed for the characterization of the porosity and surface area within the exemplified materials. In a sample tube, 150-300 milligrams of material was degassed at room temperature under ultra-high vacuum <7 mTorr to remove residual solvent and other adsorbates, with leak test performed to make sure leak rate slower than 2 mTorr/min. The degas procedure for materials was over 24 hours at room temperature. Nitrogen sorption isotherms at 77 K were obtained using in the relative pressure)(p/p° range from a p/p° from 0.001 to 0.995 for adsorption and in the range of 0.995 back to 0.05 for desorption with programmed tolerance and equilibrium settings. Helium was used for the void volume measurement, both at ambient temperature and at 77 K. BET specific surface areas (SA_{BET}) were calculated from nitrogen adsorption data by multipoint Brunauer-Emmett-Teller (BET) analysis. Average pore sizes and total pore volume (pore size typically up to approximately 200-300 nm) were calculated by last adsorption point in the isotherm at p/p° equal to approximately 0.995. Density Functional Theory (DFT) was used for pore size distribution analysis.

### Ammonia Lifetime Cartridge Test

A simple flow-through custom-built delivery system was used to deliver known concentrations of ammonia to the sample for measurement. Stainless steel and poly(vinyl chloride) (PVC) tubing was used throughout the delivery system. Ammonia was delivered to the system from an anhydrous ammonia pressurized gas cylinder (Oxygen Service Company, St. Paul, Minn., USA). The ammonia stream was diluted with compressed air to deliver a 1080 ppm stream of ammonia at a flow of 32 L/minute (LPM) to the test chamber. The air flow rate was set using a 0-300 LPM TSI flowmeter (TSI, Shoreview, Minn.). The ammonia concentration was determined by a series of titrations. A 1 LPM flow of the challenge gas was pulled into a 15 mL impinger and bubbled through a 4% by weight aqueous boric acid solution. After about 15 minutes, the contents were poured into a beaker and a few drops of bromocresol green were added. 0.10 M hydrochloric acid (HCl) was metered into the mixture until the mixture turned from blue to yellow. The relative humidity (RH) of the ammonia test was maintained at a constant 50% RH using a proportional integral derivative (PID) controller which detects the % RH of the system and heats a water bath to raise the humidity if it falls outside 0.2% of the desired % RH. The PID sensor was calibrated with a Vaisala HMM1014A1AE humidity probe (Vaisala, Vanta, Finland).

A cartridge was placed in a test chamber in line with the system allowing the 1080 ppm ammonia/50% RH gas stream to flow through the cartridge. To the downstream side of the test chamber, tubing was connected that led to a photoacoustic gas detector Innova 1412 (California Analytical, Orange, Calif.). At the time the ammonia gas stream began to pass through the cartridge, the test was considered started, and a timer was started. The Innova photoacoustic gas detector sampled approximately every 50 seconds, and the system was flushed between samples.

Prior to testing, a certified 57 ppm ammonia in nitrogen pressurized gas cylinder (Oxygen Services Company, St. Paul, Minn., USA) was used to calibrate the photoacoustic gas detector. The signal generated by this effluent was used to set the software to 50 ppm ammonia. The end point of the ammonia vapor test was defined as the point corresponding to the time at which the ammonia effluent passing through the bed of test material produced a signal on the photoacoustic gas detector that exceeded the signal corresponding to 50 ppm. The performance of each cartridge was reported as the number of minutes until 50 ppm breakthrough was observed performing the test as described above.

### Ammonia Lifetime Disposable Respirator Test

A simple flow-through custom-built delivery system was used to deliver known concentrations of ammonia to the disposable respirator for measurement. Stainless steel and PVC tubing was used throughout the delivery system. Ammonia was delivered to the system from an anhydrous ammonia pressurized gas cylinder (Oxygen Service Company, St. Paul, Minn., USA). The ammonia stream was diluted with compressed air to deliver a 55 ppm stream of ammonia at a flow of 30 LPM to the test chamber. The air flow rate was set using a 0-300 LPM TSI flowmeter (TSI, Shoreview, Minn.). The RH of the test was maintained at a constant 50% RH using a PID controller. The PID sensor was calibrated with a Vaisala HMM1014A1AE humidity probe (Vaisala, Vanta, Finland) The ammonia concentration was determined using a photoacoustic gas detector Innova 1412 (California Analytical, Orange, Calif.).

A respirator was placed in a test chamber in line with the system, allowing the 55 ppm ammonia gas stream to flow through the test material. To the downstream side of the test chamber, tubing was connected that led to the photoacoustic gas detector. At the time the ammonia gas stream began to pass through the disposable respirator, the test was considered started, and a timer was started. The Innova photoacoustic gas detector sampled approximately every 50 seconds, and the system was flushed between samples.

Prior to testing, a certified 57 ppm ammonia in nitrogen pressurized gas cylinder (Oxygen Services Company, St. Paul, Minn., USA) was used to calibrate the photoacoustic gas detector. The signal generated by this effluent was used to set the software to 50 ppm ammonia. The end point of the ammonia vapor test was defined as the point corresponding to the time at which the ammonia effluent passing through the bed of test material produced a signal on the photoacoustic gas detector that exceeded a signal corresponding to 5 ppm. The performance of each disposable respirator was reported as the number of minutes until 5 ppm breakthrough was observed performing the test as described above.

### Representative Example

A batch of porous silica was made in a generally similar manner as described in Comparative Example 1 (CE1) of U.S. Provisional Patent Application 62/269,647. The porous silica had a SA_{BET} in the range of approximately 970 m²/gram, an average pore size in the range of approximately of 4.1 nm and total pore volume in the range of approximately of 0.99 cm³/gram (measured at a p/p° equal to 0.995). The porous silica was sieved to 12×60 mesh particles. An aqueous suspension of the porous silica was prepared and treated with an ethanolic solution of isooctyltrimethoxysilane (IOS) followed by addition of ZnCl₂ in a generally similar manner as described in Example 2 of the above-referenced US'647 application. The metal-containing (ZnCl₂-impregnated, in this instance) silica was sieved to 20×40 mesh.

A filter cartridge was obtained from 3M Company, St. Paul, Minn., of a type usable with the 3M HALF FACEPIECE REUSABLE RESPIRATOR 6000 SERIES. The cartridge was empty as obtained and comprised an empty interior volume of approximately 105 mL. The cartridge was filled with a 65 mL/40 mL co-mingled mixture of 12×30 mesh particles of activated carbon obtained from Jacobi Carbons, Inc. (Columbus, Ohio) under the trade designation GA1 and 20×40 mesh particles of the ZnCl₂-impregnated porous silica described above, respectively. This activated carbon was denoted by the supplier as being usable for capture of organic vapors and was not described by the supplier as having been treated to impart any significant ability to capture volatile amines such as ammonia. By mass, this cartridge contained 30.8 g of GA1 carbon and 31.6 g of ZnCl₂-impregnated porous silica. Volumetric measurement of each sorbent was accomplished using a vibratory feeder and a 100 mL graduated cylinder. The vibratory feeder was set such that the fill rate into the cylinder was approximately 1 mL/second. When the cylinder had filled to contain the desired volume of sorbent particles, the feeder was stopped. For the blended-bed (co-mingled) configuration of this cartridge, the volumes of each sorbent were mixed together prior to loading the cartridge. This mixture of sorbents was then fed via a custom-built storm-fill tube into a cartridge body. The lid of the cartridge was then put in place with ultra-sonic welding. This cartridge was used to perform the ammonia lifetime cartridge test as described above at 50% RH and 32 LPM to determine the lifetime of the cartridge. The lifetime of the cartridge was determined to be approximately 70.2 minutes.

### Comparative Example (1)

An activated carbon was obtained and impregnated with ZnCl₂ in generally similar manner as described in Comparative Example 3 of U.S. Provisional Patent Application No. 62/298,089. An empty filter cartridge housing was obtained as described in the Representative Example and the 105 mL interior volume of the cartridge housing was filled with the ZnCl₂-impregnated activated carbon to form a packed bed. Volumetric measurement of the sorbent was accomplished using a vibratory feeder and a 100 mL graduated cylinder. The vibratory feeder was set such that the fill rate into the cylinder was approximately 1 mL/second. When the cylinder had filled to contain the desired volume of sorbent particles, the feeder was stopped. The sorbent was then fed via a custom-built storm-fill tube into a cartridge body. The lid of the cartridge was then put in place with ultrasonic welding. By mass, this cartridge contained 61.9 grams of ZnCl₂-impregnated activated carbon. This cartridge was used to perform an ammonia lifetime cartridge test as described above, at 50% RH and 32 LPM to determine the lifetime of the cartridge. The lifetime of the cartridge was determined to be approximately 79.5 minutes.

This application incorporates by reference U.S. Provisional Patent Application 62/269,647 as noted earlier herein. That application contain working examples in which various metal-containing sorbent particles were made and their performance compared to various comparative examples. Although those working examples are not reproduced in the present application for reasons of brevity, the performance of thoseworking examples as described in the US'647 application would lead an ordinary artisan to expect that the properties (in particular the enhanced ability to sorb basic, nitrogen-containing compounds such as ammonia) displayed by those working example sorbents would be similarly exhibited were these sorbents to be disposed on a suitable filter support in the manner disclosed in the present application.

Some Working Examples have included results presented in terms of the “ammonia lifetime” achieved by various formulations and configurations. It will be appreciated that the use of a parameter such as an “ammonia lifetime” is purely for convenience in characterizing an enhanced ability to sorb basic, nitrogen-containing compounds; a relatively low value of such a parameter does not necessarily imply that a particular formulation or configuration cannot exhibit satisfactory filtration performance (e.g. in terms of passing any applicable government standards). It will also be appreciated that the achievement of a relatively long ammonia lifetime may indicate that with a particular formulation or configuration, a reduced amount of sorbent and/or a reduced amount of metal impregnated thereinto may be able to be used while still meeting all applicable performance standards.

The foregoing Examples have been provided for clarity of understanding only, and no unnecessary limitations are to be understood therefrom. The tests and test results described in the Examples are intended to be illustrative rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein, this specification as written will control.

1. An air filter comprising a filter support that supports metal-containing sorbent particles, wherein at least some of the sorbent particles comprise:
a) a precursor comprising a reaction product of a mixture comprising
1) a porous siliceous material having mesopores; and
2) a surface treatment agent in an amount in a range of 0.1 to 4.5 mmoles per gram
of the porous siliceous material, the surface treatment agent comprising
(a) a silane of Formula (I)
R¹—Si(R²)₃₋ₓ(R³)ₓ (I)
wherein
R¹ is a hydrocarbon or fluorinated hydrocarbon group;
R² is a hydrolyzable group;
R³ is a non-hydrolyzable group;
x in an integer equal to 0, 1, or 2; or
(b) a disilazane of Formula (II)
(R⁴)₃—Si—NH—Si(R⁴)₃ (II)
wherein each R⁴ is a hydrocarbon group; or
(c) a mixture of the silane of Formula (I) and the disilazane of Formula (II); and
b) a divalent metal incorporated into the precursor in an amount equal to at least 1 weight percent based on the total weight of the sorbent particles.

2. The air filter of claim 1 wherein the filter support comprises a substrate with at least one major surface with at least some of the sorbent particles disposed thereon.

3. (canceled)

4. The air filter of claim 1 wherein the filter support comprises a porous, air-permeable material with the sorbent particles disposed on a major surface thereof and/or with the sorbent particles disposed within the interior of the material at least in a location proximate the major surface of the material.

5. The air filter of claim 4 wherein the sorbent particles are disposed throughout the interior of the porous, air-permeable material.

6-8. (canceled)

9. The air filter of claim 1 wherein the filter support comprises a fibrous web that exhibits an interior and wherein the sorbent particles are disposed within at least portions of the interior of the web.

10. The air filter of claim 9 wherein the sorbent particles are disposed throughout an interior of the fibrous web.

11. The air filter of claim 9 wherein the web is a nonwoven fibrous web.

12. (canceled)

13. The air filter of claim 9 wherein at least some fibers of the fibrous web are each bonded to at least one of the sorbent particles.

14. The air filter of claim 1 wherein the filter support is one layer of a multilayer, air-permeable assembly.

15. The air filter of claim 14 wherein the multilayer air-permeable assembly includes at least one layer that is not the same layer as the filter support and that is a particle-filtration layer exhibiting a Percent Penetration of less than 50.

16. The air filter of claim 15 wherein the particle-filtration layer comprises electret moities.

17. (canceled)

18. The air filter of claim 1 wherein the filter support is pleated.

19. The air filter of claim 1 wherein the air filter is a framed air filter that is configured to be inserted into an air filter receptacle of an air-handling apparatus chosen from the group consisting of a forced air heating unit, a forced air cooling unit, a forced-air heating/cooling unit, a room air purifier, and a cabin air filtration unit for a motor vehicle.

20. (canceled)

21. The air filter of claim 1 wherein the filter support provides a layer of a filtering face-piece respirator.

22. (canceled)

23. The air filter of claim 1 wherein the filter support comprises a container with an interior within which the sorbent particles are disposed, and with at least one air inlet and at least one air outlet.

24. The air filter of claim 23 wherein the filter support comprises a filter cartridge.

25. (canceled)

26. A method of capturing at least some of a basic, nitrogen-containing compounds having a molecular weight no greater than 150 grams/mole from air, the method comprising:
positioning the air filter of claim 1 so that the sorbent particles are exposed to the air; and,
sorbing at least some of the basic, nitrogen-containing compound onto the sorbent particles.

27. The method of claim 26, wherein the filter support exhibits a major surface and wherein the air is present in the form of an airstream moving in a direction that is at least generally aligned with a plane of the major surface of the filter support.

28. The method of claim 26 wherein the filter support allows airflow therethrough and wherein the air is present in the form of an airstream that passes through at least a portion the filter support in a direction at least generally perpendicular to a major surface of the filter support.

29. A method of making an air filter comprising a filter support that comprises metal-containing sorbent particles, the method comprising:
a) providing a porous siliceous material having mesopores;
b) treating the porous siliceous material with a surface treatment agent to form a precursor, wherein treating comprises adding 0.1 to 4.5 mmoles of the surface treatment agent per gram of the porous siliceous material, the surface treatment agent comprising
1) a silane of Formula (I)
R¹—Si(R²)₃₋ₓ(R³)ₓ (I)
wherein
R¹ is a hydrocarbon or fluorinated hydrocarbon group;
R² is a hydrolyzable group;
R³ is a non-hydrolyzable group;
x is an integer equal to 0, 1, or 2; or
2) a disilazane of Formula (II)
(R⁴)₃—Si—NH—Si(R⁴)₃ (II)
wherein each R⁴ is a hydrocarbon group; or
3) a mixture of the silane of Formula (I) and the disilazane of Formula (II); and
c) incorporating a divalent metal into the precursor to form the metal-containing sorbent particles, wherein the divalent metal is incorporated in an amount equal to at least 1 weight percent based on the total weight of the sorbent particles; and,
d) supporting the metal-containing sorbent particles on a filter support.
